(19) United States
(12) Patent Application Publication
(10) Pub. No.: US 2021/0238463 A1
(43) Pub. Date: Aug. 5, 2021

(54) TACKIFIED AND FILLED SILICONE ADHESIVE COMPOSITIONS

(71) Applicant: 3M INNOVATIVE PROPERTIES COMPANY, St. Paul, MN (US)

(72) Inventors: Payam Khodaparast, Minneapolis, MN (US); Michael B. Runge, Stillwater, MN (US); Kent C. Hackbarth, River Falls, WI (US); Sonja S. Mackey, St. Paul, MN (US); David J. Kinning, Stillwater, MN (US)

(21) Appl. No.: 17/270,107

(22) PCT Filed: Aug. 21, 2019
(86) PCT No.: PCT/IB2019/057054

§ 371 Date: Feb. 22, 2021

Related U.S. Application Data
(60) Provisional application No. 62/721,958, filed on Aug. 23, 2018.

(51) Int. Cl. C09J 183/04; C09J 7/35; C09J 7/38; C09J 183/10; C09J 177/06; C09J 175/02

(52) U.S. Cl. CPC C09J 183/04; C09J 7/35; C09J 7/38; C09J 183/10; C08K 3/36; C09J 175/02; C09J 2301/408; C09J 2203/366; C09J 2483/00; C09J 177/06

(57) ABSTRACT

The present disclosure generally relates to adhesive compositions and articles including at least one of polydiorganosiloxane polyoxamide copolymer, silicone polyurea block copolymer, and/or an addition cure silicone, a silicate tackifying resin, and inorganic particle filler. The filler is typically fumed silica. Some embodiments of the adhesive composition include at least one of a polydiorganosiloxane polyoxamide copolymer, a silicate tackifying resin in an amount of between about 10 wt % and about 70 wt %, and inorganic particle filler in between about 0.1 wt % and about 20 wt %; a silicone polyurea block copolymer, a silicate tackifying resin in an amount of between about 10 wt % and about 70 wt %, and inorganic particle filler in an amount between about 0.1 wt % and about 20 wt %; and an addition cure silicone, a silicate tackifying resin in an amount of between about 10 wt % and about 70 wt %, and inorganic particle filler in an amount between about 0.1 wt % and about 20 wt %.

### TECHNICAL FIELD

The present disclosure generally relates to adhesive compositions and articles including a silicone polymer, a silicate tackifying resin, and an inorganic filler.

### SUMMARY

The inventors of the present disclosure recognized that an adhesive composition or article including at least one of (1) a polydiorganosiloxane polyoxamide copolymer, a silicate tackifying resin in an amount of between about 10 wt % and about 70 wt %, and inorganic particle filler in between about 0.1 wt % and about 20 wt %; (2) a silicone polyurea block copolymer, a silicate tackifying resin in an amount of between about 10 wt % and about 70 wt %, and inorganic particle filler in an amount between about 0.1 wt % and about 20 wt %; and (3) an addition cure silicone, a silicate tackifying resin in an amount of between about 10 wt % and about 70 wt %, and inorganic particle filler in an amount between about 0.1 wt % and about 20 wt %, had various advantage or benefits. Adhesive articles featuring such adhesive compositions demonstrate at least one of damage free removal, repositionability, and high shear strength, even in wet or humid environments. Presently preferred adhesive compositions demonstrate all three. Such compositions may also demonstrate reduced adhesion to certain silicone release liners, allowing a user to quickly prepare an article for object mounting or other adhesive-related endeavor.

Adhesive compositions, adhesive articles, and methods of making the adhesive articles are provided. The polydiorganosiloxane polyoxamide copolymers can contain a relatively large fraction of polydiorganosiloxane compared to many known polydiorganosiloxane polyamide copolymers. The adhesive compositions can be formulated as either a pressure sensitive adhesive or as a heat activated adhesive.

In a first aspect, an adhesive composition is provided that includes at least one of (1) a polydiorganosiloxane polyoxamide copolymer, a silicate tackifying resin in an amount of between about 10 wt % and about 70 wt %, and inorganic particle filler in between about 0.1 wt % and about 20 wt %; (2) a silicone polyurea block copolymer, a silicate tackifying resin in an amount of between about 10 wt % and about 70 wt %, and inorganic particle filler in an amount between about 0.1 wt % and about 20 wt %; and (3) an addition cure silicone, a silicate tackifying resin in an amount of between about 10 wt % and about 70 wt %, and inorganic particle filler in an amount between about 0.1 wt % and about 20 wt %. The inorganic filler is typically fumed silica. In some embodiments, the polydiorganosiloxane polyoxamide contains at least two repeat units of Formula I.

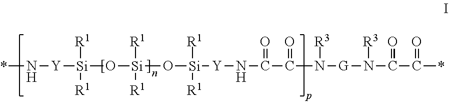

In this formula, each R¹ is independently an alkyl, haloalkyl, aralkyl, alkenyl, aryl, or aryl substituted with an alkyl, alkoxy, or halo, wherein at least 50 percent of the R groups are methyl. Each Y is independently an alkylene, aralkylene, or a combination thereof. Subscript n is independently an integer of 40 to 1500 and subscript p is an integer of 1 to 10. Group G is a divalent group that is the residue unit that is equal to a diamine of formula R³HN-G-NHR³ minus the two —NHR³ groups (i.e., amino groups). Group R³ is hydrogen or alkyl or R³ taken together with G and with the nitrogen to which they are both attached forms a heterocyclic group. Each asterisk (*) indicates a site of attachment of the repeat unit to another group in the copolymer such as, for example, another repeat unit of Formula I. In some embodiments, the silicone containing polymer is formed by an addition cure reaction between vinyl-terminated poly(dimethylsiloxane) (PDMS) and hydrogen terminated PDMS, in the presence of a hydrosilation catalyst (e.g., platinum complex)

In a second aspect, an article is provided that includes a substrate and an adhesive layer adjacent to at least one surface of the substrate. The adhesive layer includes at least one of (1) a polydiorganosiloxane polyoxamide copolymer, a silicate tackifying resin in an amount of between about 0.1 wt % and about 70 wt %, and inorganic particle filler in between about 0.1 wt % and about 20 wt %; (2) a silicone polyurea block copolymer, a silicate tackifying resin in an amount of between about 10 wt % and about 70 wt %, and inorganic particle filler in an amount between about 0.1 wt % and about 20 wt %; and (3) an addition cure silicone, a silicate tackifying resin in an amount of between about 10 wt % and about 70 wt %, and inorganic particle filler in an amount between about 0.1 wt % and about 20 wt %.

In a third aspect, a method of making an article is provided. The method includes providing a substrate and applying an adhesive composition to at least one surface of the substrate. The adhesive composition includes including at least one of at least one of (1) a polydiorganosiloxane polyoxamide copolymer, a silicate tackifying resin in an amount of between about 0.1 wt % and about 70 wt %, and inorganic particle filler in between about 0.1 wt % and about 20 wt %; (2) a silicone polyurea block copolymer, a silicate tackifying resin in an amount of between about 10 wt % and about 70 wt %, and inorganic particle filler in an amount between about 0.1 wt % and about 20 wt %; and (3) an addition cure silicone, a silicate tackifying resin in an amount of between about 10 wt % and about 70 wt %, and inorganic particle filler in an amount between about 0.1 wt % and about 20 wt %.

The above summary of the present disclosure is not intended to describe each disclosed embodiment or every implementation of the present disclosure. The description that follows more particularly exemplifies illustrative embodiments. In several places throughout the application, guidance is provided through lists of examples, which can be used in various combinations. In each instance, the recited list serves only as a representative group and should not be interpreted as an exclusive list.

### DETAILED DESCRIPTION OF THE DISCLOSURE

Adhesive compositions and articles are provided that include at least one of (1) a polydiorganosiloxane polyoxamide copolymer, a silicate tackifying resin in an amount of between about 10 wt % and about 70 wt %, and inorganic particle filler in between about 0.1 wt % and about 10 wt %; (2) a silicone polyurea block copolymer, a silicate tackifying resin in an amount of between about 10 wt % and about 70 wt %, and inorganic particle filler in an amount between about 0.1 wt % and about 20 wt %; and (3) an addition cure silicone, a silicate tackifying resin in an amount of between about 10 wt % and about 70 wt %, and inorganic particle filler in an amount between about 0.1 wt % and about 20 wt %. The inorganic particle filler is typically fumed silica. The adhesive compositions can be either pressure sensitive adhesives or heat activated adhesives.

### Definitions

The terms “a”, “an”, and “the” are used interchangeably with “at least one” to mean one or more of the elements being described.

The term “addition cure silicone” refers to a polymer that results a reaction of a vinyl terminated oligomer/polymer, such as a vinyl terminated polydimethylsiloxane (PDMS), with a hydride containing oligomer/polymer, such as a PDMS containing a silicon hydride, typically in the presence of a platinum catalyst;

The term “alkenyl” refers to a monovalent group that is a radical of an alkene, which is a hydrocarbon with at least one carbon-carbon double bond. The alkenyl can be linear, branched, cyclic, or combinations thereof and typically contains 2 to 20 carbon atoms. In some embodiments, the alkenyl contains 2 to 18, 2 to 12, 2 to 10, 4 to 10, 4 to 8, 2 to 8, 2 to 6, or 2 to 4 carbon atoms. Exemplary alkenyl groups include ethenyl, n-propenyl, and n-butenyl.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “alkylene” refers to a divalent group that is a radical of an alkane. The alkylene can be straight-chained, branched, cyclic, or combinations thereof. The alkylene often has 1 to 20 carbon atoms. In some embodiments, the alkylene contains 1 to 18, 1 to 12, 1 to 10, 1 to 8, 1 to 6, or 1 to 4 carbon atoms. The radical centers of the alkylene can be on the same carbon atom (i.e., an alkylidene) or on different carbon atoms.

The term “alkoxy” refers to a monovalent group of formula —OR where R is an alkyl group.

The term “alkoxycarbonyl” refers to a monovalent group of formula —(CO)OR where R is an alkyl group and (CO) denotes a carbonyl group with the carbon attached to the oxygen with a double bond.

The term “aralkyl” refers to a monovalent group of formula —R^{a}—Ar where R^{a} is an alkylene and Ar is an aryl group. That is, the aralkyl is an alkyl substituted with an aryl.

The term “aralkylene” refers to a divalent group of formula —R^{a}—Ar^{a}— where R^{a} is an alkylene and Ar^{a} is an arylene (i.e., an alkylene is bonded to an arylene).

The term “aryl” refers to a monovalent group that is aromatic and carbocyclic. The aryl can have one to five rings that are connected to or fused to the aromatic ring. The other ring structures can be aromatic, non-aromatic, or combinations thereof. Examples of aryl groups include, but are not limited to, phenyl, biphenyl, terphenyl, anthryl, naphthyl, acenaphthyl, anthraquinonyl, phenanthryl, anthracenyl, pyrenyl, perylenyl, and fluorenyl.

The term “arylene” refers to a divalent group that is carbocyclic and aromatic. The group has one to five rings that are connected, fused, or combinations thereof. The other rings can be aromatic, non-aromatic, or combinations thereof. In some embodiments, the arylene group has up to 5 rings, up to 4 rings, up to 3 rings, up to 2 rings, or one aromatic ring. For example, the arylene group can be phenylene.

The term “aryloxy” refers to a monovalent group of formula —OAr where Ar is an aryl group.

The term “carbonyl” refers to a divalent group of formula —(CO)— where the carbon atom is attached to the oxygen atom with a double bond.

The term “halo” refers to fluoro, chloro, bromo, or iodo.

The term “haloalkyl” refers to an alkyl having at least one hydrogen atom replaced with a halo. Some haloalkyl groups are fluoroalkyl groups, chloroalkyl groups, or bromoalkyl groups.

The term “heteroalkylene” refers to a divalent group that includes at least two alkylene groups connected by a thio, oxy, or —NR— where R is alkyl. The heteroalkylene can be linear, branched, cyclic, or combinations thereof and can include up to 60 carbon atoms and up to 15 heteroatoms. In some embodiments, the heteroalkylene includes up to 50 carbon atoms, up to 40 carbon atoms, up to 30 carbon atoms, up to 20 carbon atoms, or up to 10 carbon atoms. Some heteroalkylenes are polyalkylene oxides where the heteroatom is oxygen.

The term “oxalyl” refers to a divalent group of formula —(CO)—(CO)— where each (CO) denotes a carbonyl group.

The terms “oxalylamino” and “aminoxalyl” are used interchangeably to refer to a divalent group of formula —(CO)—(CO)—NH— where each (CO) denotes a carbonyl.

The term “aminoxalylamino” refers to a divalent group of formula —NH—(CO)—(CO)—NR^{d}— where each (CO) denotes a carbonyl group and R^{d} is hydrogen, alkyl, or part of a heterocyclic group along with the nitrogen to which it is attached. In most embodiments, R is hydrogen or alkyl. In many embodiments, R^{d} is hydrogen.

The terms “polymer” and “polymeric material” refer to both materials prepared from one monomer such as a homopolymer or to materials prepared from two or more monomers such as a copolymer, terpolymer, or the like. Likewise, the term “polymerize” refers to the process of making a polymeric material that can be a homopolymer, copolymer, terpolymer, or the like. The terms “copolymer” and “copolymeric material” refer to a polymeric material prepared from at least two monomers.

The term “polydiorganosiloxane” refers to a divalent segment of formula

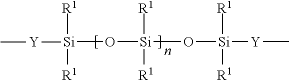

where each R¹ is independently an alkyl, haloalkyl, aralkyl, alkenyl, aryl, or aryl substituted with an alkyl, alkoxy, or halo; each Y is independently an alkylene, aralkylene, or a combination thereof, and subscript n is independently an integer of 40 to 1500.

The term “adjacent” means that a first layer is positioned near a second layer. The first layer can contact the second layer or can be separated from the second layer by one or more additional layers.

The terms “room temperature” and “ambient temperature” are used interchangeably to mean a temperature in the range of 20° C. to 25° C.

Unless otherwise indicated, all numbers expressing feature sizes, amounts, and physical properties used in the specification and claims are to be understood as being modified in all instances by the term “about”. Accordingly, unless indicated to the contrary, the numbers set forth are approximations that can vary depending upon the desired properties using the teachings disclosed herein.

### Adhesive Compositions

The present disclosure generally relates to adhesive articles that can be removed from a substrate, wall, or surface (generally, an adherend) without damage. In presently preferred implementations described herein, the adhesive composition is peelable. In other implementations, the releasable layer is stretch-releasable. The resulting adhesive article can be attached to or positioned adjacent to a hardgood.

The adhesive articles include the adhesive compositions herein provide excellent adhesion and shear holding power during use as well as damage-free removal from the wall, surface, or substrate to which the adhesive article is adhered, mounted, or attached. In embodiments featuring a stretch releasable adhesive, the article can be removed from a substrate or surface by stretching it at an angle of less than 35°. In embodiments featuring a peel-releasable (i.e., peelable) adhesive, the article is a single or multilayer construction that can be removed from a substrate or surfaces by stretching it an angle of 35° or greater. In some embodiments, the releasable adhesive may be removed by a combination of stretch and peel-release mechanisms.

As previously noted, the present disclosure generally relates to adhesive articles that can be removed from a substrate without damage. As used herein, the terms “without damage” and “damage-free” or the like means the adhesive article can be separated from the substrate without causing visible damage to paints, coatings, resins, coverings, or the underlying substrate and/or leaving behind residue. Visible damage to the substrates can be in the form of, for example, scratching, tearing, delaminating, breaking, crumbling, straining, blistering, bubbling, and the like to any layers of the substrate. Visible damage can also be discoloration, weakening, changes in gloss, changes in haze, or other changes in appearance of the substrate.

Adhesive compositions of the present disclosure included a silicone polymer, a tackifying resin, and filler. The adhesive compositions can be at least one of pressure sensitive and heat-activated, as those terms are defined below. In some embodiments, the adhesive composition includes at least one of (1) a polydiorganosiloxane polyoxamide copolymer, a silicate tackifying resin, and an inorganic particle filler; (2) a silicone polyurea block copolymer, a silicate tackifying resin, and an inorganic particle filler; or an addition cure silicone, a silicate tackifying resin, and an inorganic particle filler.

### Silicone Polymers

In some embodiments featuring a polydiorganosiloxane polyoxamide copolymer, the copolymer contains at least two repeat units of Formula I.

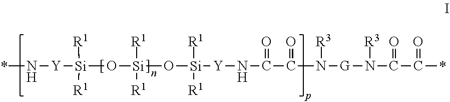

In this formula, each R¹ is independently an alkyl, haloalkyl, aralkyl, alkenyl, aryl, or aryl substituted with an alkyl, alkoxy, or halo, wherein at least 50 percent of the R groups are methyl. Each Y is independently an alkylene, aralkylene, or a combination thereof. Subscript n is independently an integer of 40 to 1500 and the subscript p is an integer of 1 to 10. Group G is a divalent group that is the residue unit that is equal to a diamine of formula R³HN-G-NHR³ minus the two —NHR³ groups. Group R³ is hydrogen or alkyl (e.g., an alkyl having 1 to 10, 1 to 6, or 1 to 4 carbon atoms) or R³ taken together with G and with the nitrogen to which they are both attached forms a heterocyclic group (e.g., R³HN-G-NHR³ is piperazine or the like). Each asterisk (*) indicates a site of attachment of the repeat unit to another group in the copolymer such as, for example, another repeat unit of Formula I.

Suitable alkyl groups for R¹ in Formula I typically have 1 to 10, 1 to 6, or 1 to 4 carbon atoms. Exemplary alkyl groups include, but are not limited to, methyl, ethyl, isopropyl, n-propyl, n-butyl, and iso-butyl. Suitable haloalkyl groups for R¹ often have only a portion of the hydrogen atoms of the corresponding alkyl group replaced with a halogen. Exemplary haloalkyl groups include chloroalkyl and fluoroalkyl groups with 1 to 3 halo atoms and 3 to 10 carbon atoms. Suitable alkenyl groups for R¹ often have 2 to 10 carbon atoms. Exemplary alkenyl groups often have 2 to 8, 2 to 6, or 2 to 4 carbon atoms such as ethenyl, n-propenyl, and n-butenyl. Suitable aryl groups for R¹ often have 6 to 12 carbon atoms. Phenyl is an exemplary aryl group. The aryl group can be unsubstituted or substituted with an alkyl (e.g., an alkyl having 1 to 10 carbon atoms, 1 to 6 carbon atoms, or 1 to 4 carbon atoms), an alkoxy (e.g., an alkoxy having 1 to 10 carbon atoms, 1 to 6 carbon atoms, or 1 to 4 carbon atoms), or halo (e.g., chloro, bromo, or fluoro). Suitable aralkyl groups for R¹ usually have an alkylene group having 1 to 10 carbon atoms and an aryl group having 6 to 12 carbon atoms. In some exemplary aralkyl groups, the aryl group is phenyl and the alkylene group has 1 to 10 carbon atoms, 1 to 6 carbon atoms, or 1 to 4 carbon atoms (i.e., the structure of the aralkyl is alkylene-phenyl where an alkylene is bonded to a phenyl group).

In some embodiments, at least 50 percent of the R¹ groups are methyl. For example, at least 60 percent, at least 70 percent, at least 80 percent, at least 90 percent, at least 95 percent, at least 98 percent, or at least 99 percent of the R¹ groups can be methyl. The remaining R¹ groups can be selected from an alkyl having at least two carbon atoms, haloalkyl, aralkyl, alkenyl, aryl, or aryl substituted with an alkyl, alkoxy, or halo.

Each Y in Formula I is independently an alkylene, aralkylene, or a combination thereof. Suitable alkylene groups typically have up to 10 carbon atoms, up to 8 carbon atoms, up to 6 carbon atoms, or up to 4 carbon atoms. Exemplary alkylene groups include methylene, ethylene, propylene, butylene, and the like. Suitable aralkylene groups usually have an arylene group having 6 to 12 carbon atoms bonded to an alkylene group having 1 to 10 carbon atoms. In some exemplary aralkylene groups, the arylene portion is phenylene. That is, the divalent aralkylene group is phenylene-alkylene where the phenylene is bonded to an alkylene having 1 to 10, 1 to 8, 1 to 6, or 1 to 4 carbon atoms. As used herein with reference to group Y, “a combination thereof” refers to a combination of two or more groups selected from an alkylene and aralkylene group. A combination can be, for example, a single aralkylene bonded to a single alkylene (e.g., alkylene-arylene-alkylene). In one exemplary alkylene-arylene-alkylene combination, the arylene is phenylene and each alkylene has 1 to 10, 1 to 6, or 1 to 4 carbon atoms.

Each subscript n in Formula I is independently an integer of 40 to 1500. For example, subscript n can be an integer up to 1000, up to 500, up to 400, up to 300, up to 200, up to 100, up to 80, or up to 60. The value of n is often at least 40, at least 45, at least 50, or at least 55. For example, subscript n can be in the range of 40 to 1000, 40 to 500, 50 to 500, 50 to 400, 50 to 300, 50 to 200, 50 to 100, 50 to 80, or 50 to 60.

The subscript p is an integer of 1 to 10. For example, the value of p is often an integer up to 9, up to 8, up to 7, up to 6, up to 5, up to 4, up to 3, or up to 2. The value of p can be in the range of 1 to 8, 1 to 6, or 1 to 4.

Group G in Formula I is a residual unit that is equal to a diamine compound of formula R³HN-G-NHR³ minus the two amino groups (i.e., —NHR³ groups). Group R³ is hydrogen or alkyl (e.g., an alkyl having 1 to 10, 1 to 6, or 1 to 4 carbon atoms) or R³ taken together with G and with the nitrogen to which they are both attached forms a heterocyclic group (e.g., R³HN-G-NHR³ is piperazine). The diamine can have primary or secondary amino groups. In most embodiments, R is hydrogen or an alkyl. In many embodiments, both of the amino groups of the diamine are primary amino groups (i.e., both R³ groups are hydrogen) and the diamine is of formula H₂N-G-NH₂.

In some embodiments, G is an alkylene, heteroalkylene, polydiorganosiloxane, arylene, aralkylene, or a combination thereof. Suitable alkylenes often have 2 to 10, 2 to 6, or 2 to 4 carbon atoms. Exemplary alkylene groups include ethylene, propylene, butylene, and the like. Suitable heteroalkylenes are often polyoxyalkylenes such as polyoxyethylene having at least 2 ethylene units, polyoxypropylene having at least 2 propylene units, or copolymers thereof. Suitable polydiorganosiloxanes include the polydiorganosiloxane diamines of Formula III, which are described below, minus the two amino groups. Exemplary polydiorganosiloxanes include, but are not limited to, polydimethylsiloxanes with alkylene Y groups. Suitable aralkylene groups usually contain an arylene group having 6 to 12 carbon atoms bonded to an alkylene group having 1 to 10 carbon atoms. Some exemplary aralkylene groups are phenylene-alkylene where the phenylene is bonded to an alkylene having 1 to 10 carbon atoms, 1 to 8 carbon atoms, 1 to 6 carbon atoms, or 1 to 4 carbon atoms. As used herein with reference to group G, “a combination thereof” refers to a combination of two or more groups selected from an alkylene, heteroalkylene, polydiorganosiloxane, arylene, and aralkylene. A combination can be, for example, an aralkylene bonded to an alkylene (e.g., alkylene-arylene-alkylene). In one exemplary alkylene-arylene-alkylene combination, the arylene is phenylene and each alkylene has 1 to 10, 1 to 6, or 1 to 4 carbon atoms.

In some embodiments, the polydiorganosiloxane polyoxamide tends to be free of groups having a formula —R^{a}—(CO)—NH— where R^{a} is an alkylene. All of the carbonylamino groups along the backbone of the copolymeric material are part of an oxalylamino group (i.e., the —(CO)—(CO)—NH— group). That is, any carbonyl group along the backbone of the copolymeric material is bonded to another carbonyl group and is part of an oxalyl group. More specifically, the polydiorganosiloxane polyoxamide has a plurality of aminoxalylamino groups.

In some embodiments, the polydiorganosiloxane polyoxamide is a linear, block copolymer and can be an elastomeric material. Unlike many of the known polydiorganosiloxane polyamides that are generally formulated as brittle solids or hard plastics, the polydiorganosiloxane polyoxamides can be formulated to include greater than 50 weight percent polydiorganosiloxane segments based on the weight of the copolymer. The weight percent of the diorganosiloxane in the polydiorganosiloxane polyoxamides can be increased by using higher molecular weight polydiorganosiloxanes segments to provide greater than 60 weight percent, greater than 70 weight percent, greater than 80 weight percent, greater than 90 weight percent, greater than 95 weight percent, or greater than 98 weight percent of the polydiorganosiloxane segments in the polydiorganosiloxane polyoxamides. Higher amounts of the polydiorganosiloxane can be used to prepare elastomeric materials with lower modulus while maintaining reasonable strength.

Some of the polydiorganosiloxane polyoxamides can be heated to a temperature up to 200° C., up to 225° C., up to 250° C., up to 275° C., or up to 300° C. without noticeable degradation of the material. For example, when heated in a thermogravimetric analyzer in the presence of air, the copolymers often have less than a 10 percent weight loss when scanned at a rate 50° C. per minute in the range of 20° C. to about 350° C. Additionally, the copolymers can often be heated at a temperature such as 250° C. for 1 hour in air without apparent degradation as determined by no detectable loss of mechanical strength upon cooling.

The polydiorganosiloxane polyoxamide copolymers have many of the desirable features of polysiloxanes such as low glass transition temperatures, thermal and oxidative stability, resistance to ultraviolet radiation, low surface energy and hydrophobicity, and high permeability to many gases. Additionally, the copolymers exhibit good to excellent mechanical strength.

The copolymeric material of Formula I can be optically clear. As used herein, the term “optically clear” refers to a material that is clear to the human eye. An optically clear copolymeric material often has a luminous transmission of at least about 90 percent, a haze of less than about 2 percent, and opacity of less than about 1 percent in the 400 to 700 nm wavelength range. Both the luminous transmission and the haze can be determined using, for example, the method of ASTM-D 1003-95.

Additionally, the copolymeric material of Formula I can have a low refractive index. As used herein, the term “refractive index” refers to the absolute refractive index of a material (e.g., copolymeric material or adhesive composition) and is the ratio of the speed of electromagnetic radiation in free space to the speed of the electromagnetic radiation in the material of interest. The electromagnetic radiation is white light. The index of refraction is measured using an Abbe refractometer, available commercially, for example, from Fisher Instruments of Pittsburgh, Pa. The measurement of the refractive index can depend, to some extent, on the particular refractometer used. The copolymeric material usually has a refractive index in the range of about 1.41 to about 1.50.

The polydiorganosiloxane polyoxamides are soluble in many common organic solvents such as, for example, toluene, tetrahydrofuran, dichloromethane, aliphatic hydrocarbons (e.g., alkanes such as hexane), or mixtures thereof.

The linear block copolymers having repeat units of Formula I can be prepared, for example, as represented in Reaction Scheme A.

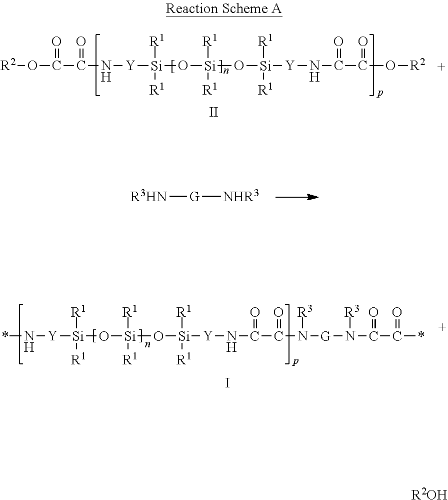

In this reaction scheme, a precursor of Formula II is combined under reaction conditions with a diamine having two primary amino groups, two secondary amino groups, or one primary amino group and one secondary amino group. The diamine is usually of formula R³HN-G-NHR³. The R²OH by-product is typically removed from the resulting polydiorganosiloxane polyoxamide.

The diamine R³HN-G-NHR³ in Reaction Scheme A has two amino groups (i.e., —NHR³). Group R³ is hydrogen or alkyl (e.g., an alkyl having 1 to 10, 1 to 6, or 1 to 4 carbon atoms) or R taken together with G and with the nitrogen to which they are both attached forms a heterocyclic group (e.g., the diamine is piperazine or the like). In most embodiments, R³ is hydrogen or alkyl. In many embodiments, the diamine has two primary amino groups (i.e., each R³ group is hydrogen) and the diamine is of formula H₂N-G-NH₂. The portion of the diamine exclusive of the two amino groups is referred to as group G in Formula I.

The diamines are sometimes classified as organic diamines or polydiorganosiloxane diamines with the organic diamines including, for example, those selected from alkylene diamines, heteroalkylene diamines, arylene diamines, aralkylene diamines, or alkylene-aralkylene diamines. The diamine has only two amino groups so that the resulting polydiorganosiloxane polyoxamides are linear block copolymers that are often elastomeric, hot melt processible (e.g., the copolymers can be processed at elevated temperatures such as up to 250° C. or higher without apparent degradation of the composition), and soluble in some common organic solvents. The diamine is free of a polyamine having more than two primary or secondary amino groups. Tertiary amines that do not react with the precursor of Formula II can be present. Additionally, the diamine is free of any carbonylamino group. That is, the diamine is not an amide.

Exemplary polyoxyalkylene diamines (i.e., G is a heteroalkylene with the heteroatom being oxygen) include, but are not limited to, those commercially available from Huntsman, The Woodlands, Tex. under the trade designation JEFFAMINE D-230 (i.e., polyoxypropylene diamine having an average molecular weight of about 230 g/mole), JEFFAMINE D-400 (i.e., polyoxypropylene diamine having an average molecular weight of about 400 g/mole), JEFFAMINE D-2000 (i.e., polyoxypropylene diamine having an average molecular weight of about 2,000 g/mole), JEFFAMINE HK-511 (i.e., polyetherdiamine with both oxyethylene and oxypropylene groups and having an average molecular weight of about 220 g/mole), JEFFAMINE ED-2003 (i.e., polypropylene oxide capped polyethylene glycol with an average molecular weight of about 2,000 g/mole), and JEFFAMINE EDR-148 (i.e., triethyleneglycol diamine).

Exemplary alkylene diamines (i.e., G is a alkylene) include, but are not limited to, ethylene diamine, propylene diamine, butylene diamine, hexamethylene diamine, 2-methylpentamethylene 1,5-diamine (i.e., commercially available from DuPont, Wilmington, Del. under the trade designation DYTEK A), 1,3-pentane diamine (commercially available from DuPont under the trade designation DYTEK EP), 1,4-cyclohexane diamine, 1,2-cyclohexane diamine (commercially available from DuPont under the trade designation DHC-99), 4,4′-bis(aminocyclohexyl)methane, and 3-aminomethyl-3,5,5-trimethylcyclohexylamine.

Exemplary arylene diamines (i.e., G is an arylene such as phenylene) include, but are not limited to, m-phenylene diamine, o-phenylene diamine, and p-phenylene diamine. Exemplary aralkylene diamines (i.e., G is an aralkylene such as alkylene-phenyl) include, but are not limited to 4-aminomethyl-phenylamine, 3-aminomethyl-phenylamine, and 2-aminomethyl-phenylamine. Exemplary alkylene-aralkylene diamines (i.e., G is an alkylene-aralkylene such as alkylene-phenylene-alkylene) include, but are not limited to, 4-aminomethyl-benzylamine, 3-aminomethyl-benzylamine, and 2-aminomethyl-benzylamine.

The precursor of Formula II in Reaction Scheme A has at least one polydiorganosiloxane segment and at least two oxalylamino groups. Group R¹, group Y, subscript n, and subscript p are the same as described for Formula I. Each group R² is independently an alkyl, haloalkyl, aryl, or aryl substituted with an alkyl, alkoxy, halo, or alkoxycarbonyl.

Suitable alkyl and haloalkyl groups for R² often have 1 to 10, 1 to 6, or 1 to 4 carbon atoms. Although tertiary alkyl (e.g., tert-butyl) and haloalkyl groups can be used, there is often a primary or secondary carbon atom attached directly (i.e., bonded) to the adjacent oxy group. Exemplary alkyl groups include methyl, ethyl, n-propyl, iso-propyl, n-butyl, and iso-butyl. Exemplary haloalkyl groups include chloroalkyl groups and fluoroalkyl groups in which some, but not all, of the hydrogen atoms on the corresponding alkyl group are replaced with halo atoms. For example, the chloroalkyl or a fluoroalkyl groups can be chloromethyl, 2-chloroethyl, 2,2,2-trichloroethyl, 3-chloropropyl, 4-chlorobutyl, fluoromethyl, 2-fluoroethyl, 2,2,2-trifluoroethyl, 3-fluoropropyl, 4-fluorobutyl, and the like. Suitable aryl groups for R² include those having 6 to 12 carbon atoms such as, for example, phenyl. An aryl group can be unsubstituted or substituted with an alkyl (e.g., an alkyl having 1 to 4 carbon atoms such as methyl, ethyl, or n-propyl), an alkoxy (e.g., an alkoxy having 1 to 4 carbon atoms such as methoxy, ethoxy, or propoxy), halo (e.g., chloro, bromo, or fluoro), or alkoxycarbonyl (e.g., an alkoxycarbonyl having 2 to 5 carbon atoms such as methoxycarbonyl, ethoxycarbonyl, or propoxycarbonyl).

The precursor of Formula II can include a single compound (i.e., all the compounds have the same value of p and n) or can include a plurality of compounds (i.e. the compounds have different values for p, different values for n, or different values for both p and n). Precursors with different n values have siloxane chains of different length. Precursors having a p value of at least 2 are chain extended. Different amounts of the chain-extended precursor of Formula II in the mixture can affect the final properties of the elastomeric material of Formula I. That is, the amount of the second compound of Formula II (i.e., p equal to at least 2) can be varied advantageously to provide elastomeric materials with a range of properties. For example, a higher amount of the second compound of Formula II can alter the melt rheology (e.g., the elastomeric material can flow easier when molten), alter the softness of the elastomeric material, lower the modulus of the elastomeric material, or a combination thereof.

In some embodiments, the precursor is a mixture of a first compound of Formula II with subscript p equal to 1 and a second compound of Formula II with subscript p equal to at least 2. The first compound can include a plurality of different compounds with different values of n. The second compound can include a plurality of compounds with different values of p, different values of n, or different values of both p and n. Mixtures can include at least 50 weight percent of the first compound of Formula II (i.e., p is equal to 1) and no greater than 50 weight percent of the second compound of Formula II (i.e., p is equal to at least 2) based on the sum of the weight of the first and second compounds in the mixture. In some mixtures, the first compound is present in an amount of at least 55 weight percent, at least 60 weight percent, at least 65 weight percent, at least 70 weight percent, at least 75 weight percent, at least 80 weight percent, at least 85 weight percent, at least 90 weight percent, at least 95 weight percent, or at least 98 weight percent based on the total amount of the compounds of Formula II. The mixtures often contain no greater than 50 weight percent, no greater than 45 weight percent, no greater than 40 weight percent, no greater than 35 weight percent, no greater than 30 weight percent, no greater than 25 weight percent, no greater than 20 weight percent, no greater than 15 weight percent, no greater than 10 weight percent, no greater than 5 weight percent, or no greater than 2 weight percent of the second compound.

Reaction Scheme A can be conducted using a plurality of precursors of Formula II, a plurality of diamines, or a combination thereof. A plurality of precursors having different average molecular weights can be combined under reaction conditions with a single diamine or with multiple diamines. For example, the precursor of Formula II may include a mixture of materials with different values of n, different values of p, or different values of both n and p. The multiple diamines can include, for example, a first diamine that is an organic diamine and a second diamine that is a polydiorganosiloxane diamine. Likewise, a single precursor can be combined under reaction conditions with multiple diamines.

The molar ratio of the precursor of Formula II to the diamine is often about 1:1. For example the molar ratio is often less than or equal to 1:0.90, less than or equal to 1:0.92, less than or equal to 1:0.95, less than or equal to 1:0.98, or less than or equal to 1:1. The molar ratio is often greater than or equal to 1:1.02, greater than or equal to 1:1.05, greater than or equal to 1:1.08, or greater than or equal to 1:1.10. For example, the molar ratio can be in the range of 1:0.90 to 1:1.10, in the range of 1:0.92 to 1:1.08, in the range of 1:0.95 to 1:1.05, or in the range of 1:0.98 to 1:1.02. Varying the molar ratio can be used, for example, to alter the overall molecular weight, which can affect the rheology of the resulting copolymers. Additionally, varying the molar ratio can be used to provide oxalylamino-containing end groups or amino end groups, depending upon which reactant is present in molar excess.

The condensation reaction of the precursor of Formula II with the diamine (i.e., Reaction Scheme A) are often conducted at room temperature or at elevated temperatures such as at temperatures up to about 250° C. For example, the reaction often can be conducted at room temperature or at temperatures up to about 100° C. In other examples, the reaction can be conducted at a temperature of at least 100° C., at least 120° C., or at least 150° C. For example, the reaction temperature is often in the range of 100° C. to 220° C., in the range of 120° C. to 220° C., or in the range of 150° C. to 200° C. The condensation reaction is often complete in less than 1 hour, in less than 2 hours, in less than 4 hours, in less than 8 hours, or in less than 12 hours.

Reaction Scheme A can occur in the presence or absence of a solvent. Suitable solvents usually do not react with any of the reactants or products of the reactions. Additionally, suitable solvents are usually capable of maintaining all the reactants and all of the products in solution throughout the polymerization process. Exemplary solvents include, but are not limited to, toluene, tetrahydrofuran, dichloromethane, aliphatic hydrocarbons (e.g., alkanes such as hexane), or mixtures thereof.

Any solvent that is present can be stripped from the resulting polydiorganosiloxane polyoxamide at the completion of the reaction. Solvents that can be removed under the same conditions used to remove the alcohol by-product are often preferred. The stripping process is often conducted at a temperature of at least 100° C., at least 125° C., or at least 150° C. The stripping process is typically at a temperature less than 300° C., less than 250° C., or less than 225° C.

Conducting Reaction Scheme A in the absence of a solvent can be desirable because only the volatile by-product, R²OH, needs to be removed at the conclusion of the reaction. Additionally, a solvent that is not compatible with both reactants and the product can result in incomplete reaction and a low degree of polymerization.

Any suitable reactor or process can be used to prepare the copolymeric material according to Reaction Scheme A. The reaction can be conducted using a batch process, semi-batch process, or a continuous process. Exemplary batch processes can be conducted in a reaction vessel equipped with a mechanical stirrer such as a Brabender mixer, provided the product of the reaction is in a molten state has a sufficiently low viscosity to be drained from the reactor. Exemplary semi-batch process can be conducted in a continuously stirred tube, tank, or fluidized bed. Exemplary continuous processes can be conducted in a single screw or twin screw extruder such as a wiped surface counter-rotating or co-rotating twin screw extruder.

In many processes, the components are metered and then mixed together to form a reaction mixture. The components can be metered volumetrically or gravimetrically using, for example, a gear, piston or progressing cavity pump. The components can be mixed using any known static or dynamic method such as, for example, static mixers, or compounding mixers such as single or multiple screw extruders. The reaction mixture can then be formed, poured, pumped, coated, injection molded, sprayed, sputtered, atomized, stranded or sheeted, and partially or completely polymerized. The partially or completely polymerized material can then optionally be converted to a particle, droplet, pellet, sphere, strand, ribbon, rod, tube, film, sheet, coextruded film, web, non-woven, microreplicated structure, or other continuous or discrete shape, prior to the transformation to solid polymer. Any of these steps can be conducted in the presence or absence of applied heat. In one exemplary process, the components can be metered using a gear pump, mixed using a static mixer, and injected into a mold prior to solidification of the polymerizing material.

The polydiorganosiloxane-containing precursor of Formula II in Reaction Scheme A can be prepared by any known method. In some embodiments, this precursor is prepared according to Reaction Scheme B.

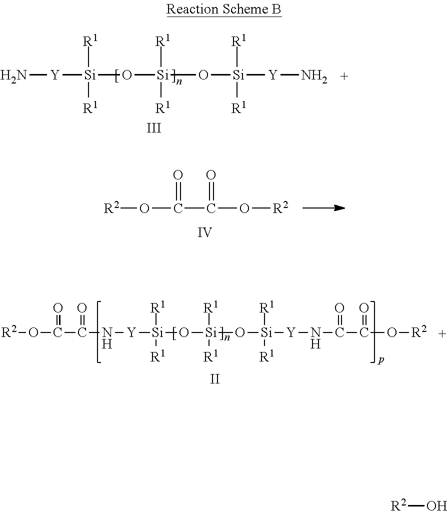

A polydiorganosiloxane diamine of Formula III (p moles) is reacted with a molar excess of an oxalate of Formula IV (greater than p+1 moles) under an inert atmosphere to produce the polydiorganosiloxane-containing precursor of Formula II and R²—OH
by-product. In this reaction, R¹, Y, n, and p are the same as previously described for Formula I. Each R² in Formula IV is independently an alkyl, haloalkyl, aryl, or aryl substituted with an alkyl, alkoxy, halo, or alkoxycarbonyl. The preparation of the precursor of Formula II according to Reaction Scheme B is further described in U.S. Publication No. 2007/0149745 (Leir et al.)

The polydiorganosiloxane diamine of Formula III in Reaction Scheme B can be prepared by any known method and can have any suitable molecular weight, such as an average molecular weight in the range of 700 to 150,000 g/mole. Suitable polydiorganosiloxane diamines and methods of making the polydiorganosiloxane diamines are described, for example, in U.S. Pat. No. 3,890,269 (Martin), U.S. Pat. No. 4,661,577 (Jo Lane et al.), U.S. Pat. No. 5,026,890 (Webb et al.), U.S. Pat. No. 5,276,122 (Aoki et al.), U.S. Pat. No. 5,214,119 (Leir et al.), U.S. Pat. No. 5,461,134 (Leir et al.), U.S. Pat. No. 5,512,650 (Leir et al.), and U.S. Pat. No. 6,355,759 (Sherman et al.), incorporated herein by reference in their entirety. Some polydiorganosiloxane diamines are commercially available, for example, from Shin Etsu Silicones of America, Inc., Torrance, Calif. and from Gelest Inc., Morrisville, Pa.

A polydiorganosiloxane diamine having a molecular weight greater than 2,000 g/mole or greater than 5,000 g/mole can be prepared using the methods described in U.S. Pat. No. 5,214,119 (Leir et al.), U.S. Pat. No. 5,461,134 (Leir et al.), and U.S. Pat. No. 5,512,650 (Leir et al.). One of the described methods involves combining under reaction conditions and under an inert atmosphere (a) an amine functional end blocker of the following formula

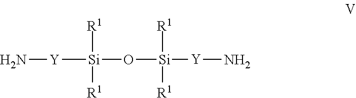

where Y and R¹ are the same as defined for Formula I; (b) sufficient cyclic siloxane to react with the amine functional end blocker to form a polydiorganosiloxane diamine having a molecular weight less than 2,000 g/mole; and (c) an anhydrous aminoalkyl silanolate catalyst of the following formula

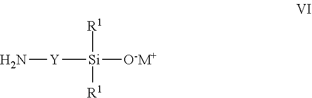

where Y and R¹ are the same as defined in Formula I and M⁺ is a sodium ion, potassium ion, cesium ion, rubidium ion, or tetramethylammonium ion. The reaction is continued until substantially all of the amine functional end blocker is consumed and then additional cyclic siloxane is added to increase the molecular weight. The additional cyclic siloxane is often added slowly (e.g., drop wise). The reaction temperature is often conducted in the range of 80° C. to 90° C. with a reaction time of 5 to 7 hours. The resulting polydiorganosiloxane diamine can be of high purity (e.g., less than 2 weight percent, less than 1.5 weight percent, less than 1 weight percent, less than 0.5 weight percent, less than 0.1 weight percent, less than 0.05 weight percent, or less than 0.01 weight percent silanol impurities). Altering the ratio of the amine end functional blocker to the cyclic siloxane can be used to vary the molecular weight of the resulting polydiorganosiloxane diamine of Formula III.

Another method of preparing the polydiorganosiloxane diamine of Formula III includes combining under reaction conditions and under an inert environment (a) an amine functional end blocker of the following formula

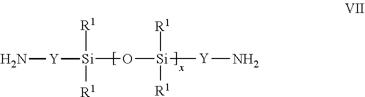

where R¹ and Y are the same as described for Formula I and where the subscript x is equal to an integer of 1 to 150; (b) sufficient cyclic siloxane to obtain a polydiorganosiloxane diamine having an average molecular weight greater than the average molecular weight of the amine functional end blocker; and (c) a catalyst selected from cesium hydroxide, cesium silanolate, rubidium silanolate, cesium polysiloxanolate, rubidium polysiloxanolate, and mixtures thereof. The reaction is continued until substantially all of the amine functional end blocker is consumed. This method is further described in U.S. Pat. No. 6,355,759 B1 (Sherman et al.). This procedure can be used to prepare any molecular weight of the polydiorganosiloxane diamine.

Yet another method of preparing the polydiorganosiloxane diamine of Formula III is described in U.S. Pat. No. 6,531,620 B2 (Brader et al.). In this method, acyclic silazane is reacted with a siloxane material having hydroxy end groups as shown in the following reaction.

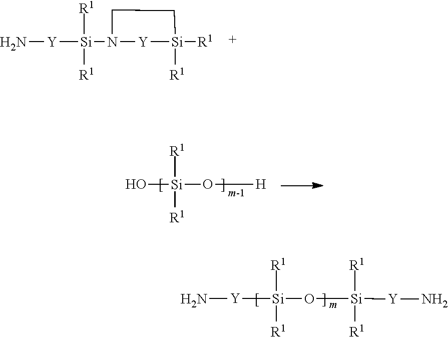

The groups R¹ and Y are the same as described for Formula I. The subscript m is an integer greater than 1.

In Reaction Scheme B, an oxalate of Formula IV is reacted with the polydiorganosiloxane diamine of Formula III under an inert atmosphere. The two R² groups in the oxalate of Formula IV can be the same or different. In some methods, the two R² groups are different and have different reactivity with the polydiorganosiloxane diamine of Formula III in Reaction Scheme B.

The oxalates of Formula IV in Reaction Scheme B can be prepared, for example, by reaction of an alcohol of formula R²—OH with oxalyl dichloride. Commercially available oxalates of Formula IV (e.g., from Sigma-Aldrich, Milwaukee, Wis. and from VWR International, Bristol, Conn.) include, but are not limited to, dimethyl oxalate, diethyl oxalate, di-n-butyl oxalate, di-tert-butyl oxalate, bis(phenyl) oxalate, bis(pentafluorophenyl) oxalate, 1-(2,6-difluorophenyl)-2-(2,3,4,5,6-pentachlorophenyl) oxalate, and bis (2,4,6-trichlorophenyl) oxalate.

A molar excess of the oxalate is used in Reaction Scheme B. That is, the molar ratio of oxalate to polydiorganosiloxane diamine is greater than the stoichiometric molar ratio, which is (p+1): p. The molar ratio is often greater than 2:1, greater than 3:1, greater than 4:1, or greater than 6:1. The condensation reaction typically occurs under an inert atmosphere and at room temperature upon mixing of the components.

The condensation reaction used to produce the precursor of Formula II (i.e., Reaction Scheme B) can occur in the presence or absence of a solvent. In some methods, no solvent or only a small amount of solvent is included in the reaction mixture. In other methods, a solvent may be included such as, for example, toluene, tetrahydrofuran, dichloromethane, or aliphatic hydrocarbons (e.g., alkanes such as hexane).

Removal of excess oxalate from the precursor of Formula II prior to reaction with the diamine in Reaction Scheme A tends to favor formation of an optically clear polydiorganosiloxane polyoxamide. The excess oxalate can typically be removed from the precursor using a stripping process. For example, the reacted mixture (i.e., the product or products of the condensation reaction according to Reaction Scheme B) can be heated to a temperature up to 150° C., up to 175° C., up to 200° C., up to 225° C., or up to 250° C. to volatilize the excess oxalate. A vacuum can be pulled to lower the temperature that is needed for removal of the excess oxalate. The precursor compounds of Formula II tend to undergo minimal or no apparent degradation at temperatures in the range of 200° C. to 250° C. or higher. Any other known methods of removing the excess oxalate can be used.

The by-product of the condensation reaction shown in Reaction Scheme B is an alcohol (i.e., R²—OH is an alcohol). Group R² is often limited to an alkyl having 1 to 4 carbon atoms, a haloalkyl having 1 to 4 carbon atoms, or an aryl such as phenyl that form an alcohol that can be readily removed (e.g., vaporized) by heating at temperatures no greater than about 250° C. Such an alcohol can be removed when the reacted mixture is heated to a temperature sufficient to remove the excess oxalate of Formula IV.

Another example of a useful class of silicone polymers is silicone polyurea block copolymers. Silicone polyurea block copolymers include the reaction product of a polydiorganosiloxane diamine (also referred to as silicone diamine), a diisocyanate, and optionally an organic polyamine. Suitable silicone polyurea block copolymers are represented by the repeating unit shown and described in International Publication No. WO2016106040 (Sherman et al.):

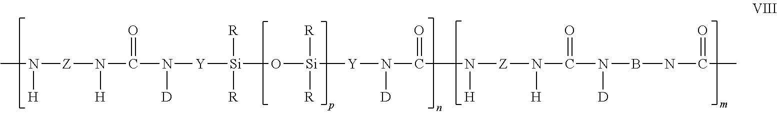

wherein each R is a moiety that, independently, is an alkyl moiety, preferably having about 1 to 12 carbon atoms, and may be substituted with, for example, trifluoroalkyl or vinyl groups, a vinyl radical or higher alkenyl radical preferably represented by the formula R² (CH₂)_{b}— or —CH₂)_{c}CH═CH₂ wherein R² is —(CH₂)_{b}— or —CH₂)_{c} CH - - - and a is 1, 2 or 3; b is 0, 3 or 6; and c is 3, 4 or 5, a cycloalkyl moiety having from about 6 to 12 carbon atoms and may be substituted with alkyl, fluoroalkyl, and vinyl groups, or an aryl moiety preferably having from about 6 to 20 carbon atoms and may be substituted with, for example, alkyl, cycloalkyl, fluoroalkyl arid vinyl groups or R is a perfluoroalkyl group as described in U.S. Pat. No. 5,028,679 (Terae et al.), and incorporated herein, or a fluorine-containing group, as described in U.S. Pat. No. 5,236,997 (Fujiki) and incorporated herein, or a perfluoroether-containing group, as described in U.S. Pat. No. 4,900,474 (Terae et al.) and U.S. Pat. No. 5,118,775 (Inomata et al.) and incorporated herein; preferably at least 50% of the R moieties are methyl radicals with the balance being monovalent alkyl or substituted alkyl radicals having from 1 to 12 carbon atoms, alkenylene radicals, phenyl radicals, or substituted phenyl radicals; each Z is a polyvalent radical that is an arylene radical or an aralkylene radical preferably having from about 6 to 20 carbon atoms, an alkylene or cycloalkylene radical preferably having from about 6 to 20 carbon atoms, preferably Z is 2,6-tolylene, 4,4′-methylenediphenylene, 3,3′-dimethoxy-4,4′-biphenylene, tetramethyl-m-xylylene, 4,4′-methylenedicyclohexylene, 3,5,5-trimethyl-3-methylenecyclohexylcne, 1,6-hexamethylene, 1,4-cyclohexylene, 2,2,4-trimethylhexylene and mixtures thereof; each Y is a polyvalent radical that independently is an alkylene radical of 1 to 10 carbon atoms, an aralkylene radical or an arylene radical preferably having 6 to 20 carbon atoms; each D is selected from the group consisting of hydrogen, an alkyl radical of 1 to 10 carbon atoms, phenyl, and a radical that completes a ring structure including B or Y to form a heterocycle; where B is a polyvalent radical selected from the group consisting of alkylene, aralkylene, cycloalkylene, phenylene, polyalkylene oxide, including for example, polyethylene oxide, polypropylene oxide, polytetramethylene oxide, and copolymers and mixtures thereof; m is a number that is 0 to about 1000; n is a number that is at least 1; and p is a number that is at least 10, preferably about 15 to about 2000, more preferably 30 to 1500.

Useful silicone polyurea block copolymers are disclosed in, e.g., U.S. Pat. Nos. 5,512,650, 5,214,119, and 5,461,134, WO 96/35458, WO 98/17726, WO 96/34028, WO 96/34030 and WO 97/40103, each incorporated herein.

Examples of useful silicone diamines used in the preparation of silicone polyurea block copolymers include polydiorganosiloxane diamines represented by the formula shown and described in U.S. Pat. No. 8,334,037 (Sheridan et al.):

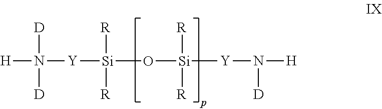

wherein each of R, Y, D, and p are defined as above. Preferably the number average molecular weight of the polydiorganosiloxane diamines is greater than about 700.

Useful polydiorganosiloxane diamines include any polydiorganosiloxane diamines that fall within Formula IX above and include those polydiorganosiloxane diamines having molecular weights in the range of about 700 to 150,000, preferably from about 10,000 to about 60,000, more preferably from about 25,000 to about 50,000. Suitable polydiorganosiloxane diamines and methods of manufacturing polydiorganosiloxane diamines are disclosed in, e.g., U.S. Pat. Nos. 3,890,269, 4,661,577, 5,026,890, and 5,276,122, International Patent Publication Nos. WO 95/03354 and WO 96/35458, each of which is incorporated herein by reference.

Examples of useful polydiorganosiloxane diamines include polydimethylsiloxane diamine, polydiphenylsiloxane diamine, polytrifluoropropylmethylsiloxane diamine, polyphenylmethylsiloxane diamine, polydiethylsiloxane diamine, polydivinylsiloxane diamine, polyvinylmethylsiloxane diamine, poly(5-hexenyl)methylsiloxane diamine, and mixtures and copolymers thereof.

Suitable polydiorganosiloxane diamines are commercially available from, for example, Shin Etsu Silicones of America, Inc., Torrance, Calif., and Huls America, Inc. Preferably the polydiorganosiloxane diamines are substantially pure and prepared as disclosed in U.S. Pat. No. 5,214,119 and incorporated herein. Polydiorganosiloxane diamines having such high purity are prepared from the reaction of cyclic organosilanes and bis(aminoalkyl)disiloxanes utilizing an anhydrous amino alkyl functional silanolate catalyst such as tetramethylammonium-3-aminopropyldimethyl silanolate, preferably in an amount less than 0.15% by weight based on the weight of the total amount of cyclic organosiloxane with the reaction run in two stages. Particularly preferred polydiorganosiloxane diamines are prepared using cesium and rubidium catalysts and are disclosed in U.S. Pat. No. 5,512,650 and incorporated herein.

The polydiorganosiloxane diamine component provides a means of adjusting the modulus of the resultant silicone polyurea block copolymer. In general, high molecular weight polydiorganosiloxane diamines provide copolymers of lower modulus whereas low molecular polydiorganosiloxane polyamines provide copolymers of higher modulus.

Examples of useful polyamines include polyoxyalkylene diamines including, e.g., polyoxyalkylene diamines commercially available under the trade designation D-230, D-400, D-2000, D-4000, ED-2001 and EDR-148 from Hunstman Corporation (Houston, Tex.), polyoxyalkylene triamines including, e.g., polyoxyalkylene triamines commercially available under the trade designations T-403, T-3000 and T-5000 from Hunstman, and polyalkylenes including, e.g., ethylene diamine and polyalkylenes available under the trade designations Dytek A and Dytek EP from DuPont (Wilmington, Del.).

The optional polyamine provides a means of modifying the modulus of the copolymer. The concentration, type and molecular weight of the organic polyamine influence the modulus of the silicone polyurea block copolymer.

The silicone polyurea block copolymer preferably includes polyamine in an amount of no greater than about 3 moles, more preferably from about 0.25 to about 2 moles. Preferably the polyamine has a molecular weight of no greater than about 300 g/mole.

Any polyisocyanate including, e.g., diisocyanates and triisocyanates, capable of reacting with the above-described polyamines can be used in the preparation of the silicone polyurea block copolymer. Examples of suitable diisocyanates include aromatic diisocyanates, such as 2,6-toluene diisocyanate, 2,5-toluene diisocyanate, 2,4-toluene diisocyanate, m-phenylene diisocyanate, p-phenylene diisocyanate, methylene bis(o-chlorophenyl diisocyanate), methylenediphenylene-4,4′-diisocyanate, polycarbodiimide-modified methylenediphenylene diisocyanate, (4,4′-diisocyanato-3,3′,5,5′-tetraethyl) diphenylmethane, 4,4-diisocyanato-3,3′-dimethoxybiphenyl (o-dianisidine diisocyanate), 5-chloro-2,4-toluene diisocyanate, and 1-chloromethyl-2,4-diisocyanato benzene, aromatic-aliphatic diisocyanates, such as m-xylylene diisocyanate and tetramethyl-m-xylylene diisocyanate, aliphatic diisocyanates such as 1,4-diisocyanatobutane, 1,6-diisocyanatohexane, 1,12-diisocyanatododecane and 2-methyl-1,5-diisocyanatopentane, and cycloaliphatic diisocyanates such as methylenedicyclohexylene-4,4′-diisocyanate, 3-isocyanatomethyl-3,5,5-trimethylcyclohexyl isocyanate (isophorone diisocyanate) and cyclohexylene-1,4-diisocyanate.

Any triisocyanate that can react with a polyamine, and in particular with the polydiorganosiloxane diamine is suitable. Examples of such triisocyanates include, e.g., polyfunctional isocyanates, such as those produced from biurets, isocyanurates, and adducts. Examples of commercially available polyisocyanates include portions of the series of polyisocyanates available under the trade designations DESMODUR and MONDUR from Bayer and PAPI from Dow Plastics.

The polyisocyanate is preferably present in a stoichiometric amount based on the amount of polydiorganosiloxane diamine and optional polyamine.

The silicone polyurea block copolymer can be prepared by solvent-based processes, solventless processes or a combination thereof. Useful solvent-based processes are described in, e.g., Tyagi et al., “Segmented Organosiloxane Copolymers: 2. Thermal and Mechanical Properties of Siloxane-Urea Copolymers”, Polymer, vol. 25, December 1984, and U.S. Pat. No. 5,214,119 (Leir et al.), and incorporated herein by reference. Useful methods of manufacturing silicone polyurea block copolymers are also described in, e.g., U.S. Pat. Nos. 5,512,650, 5,214,119, and 5,461,134, WO 96/35458, WO 98/17726, WO 96/34028, and WO 97/40103, and incorporated herein.

Other suitable silicone polymers for use in the adhesive compositions may include addition cure silicones, peroxide cure silicones, and moisture cure silicones. Silicone containing polymers prepared by addition-cure chemistry generally comprise polydiorganosiloxanes having alkenyl groups, copolymeric silicone resins comprising SiO_{4/2} and R³ SiO_{1/2} structural units wherein R is as defined previously having one or more of the following functionalities: silicone-bonded hydrogen, silicone bonded alkenyl groups such as those selected from the group consisting of vinyl, allyl, and propenyl; or silanol, optionally a crosslinking or chain extending agent, and platinum or other noble metal hydrosilation catalyst to effect the curing of the silicone adhesive. One such polymer is formed by an addition cure reaction between vinyl-terminated poly(dimethylsiloxane) (PDMS) and hydrogen terminated PDMS, in the presence of a hydrosilation catalyst (e.g., platinum complex). Vinyl-terminated and hydrogen terminated PDMS chains are referred to as ‘functionalized’ silicones due to their specific chemical moieties. Individually, such functional silicones are generally not reactive; however, together they can form a reactive silicone system. Exemplary hydrosilation catalysts are described in U.S. Pat. No. 8,202,939 (Moore et al.). One exemplary, suitable addition cure silicone is Sylgard 184, available from Dow Corning, Midland, Mich.

Generally, a peroxide cure silicone comprises prior to curing: (i) a reaction adduct of polydimethylsiloxane and/or polydiphenylsiloxane gum and silicone resin, (ii) optionally one or more silicone resins, and (iii) at least one peroxide crosslinker. In certain embodiments, such peroxide curatives extract hydrogen and/or crosslink and may require high temperatures. For example, benzoyl peroxide requires a cure temperature of more than 150° C. for the catalyst to be functional. An exemplary, suitable peroxide curative agent is Luperox 101, available from Arkema Inc., Houston, Tex.

The silicone polymer is typically present in quantities of at least 20 wt. % and no greater than 80 wt. %, based on the total weight of the adhesive composition, or any amount within that range. In certain implementations, it may be preferred that the silicone containing polymer is present at a concentration of at least 30 wt. % and no greater than 75 wt. %, based on the total weight of the adhesive composition.

### Tackifying Resin

Either pressure sensitive adhesives or heat activated adhesives can be formulated by combining the silicone-containing polymers with a silicate tackifying resin. As used herein, the term “pressure sensitive adhesive” means a material that has tack, adheres with no more than finger pressure, requires no activation by any energy source, has sufficient adhesion when applied to an adherend to hold onto the adherend at the intended use angle and with the intended load, and has sufficient cohesive strength to be removed cleanly from the adherend. As used herein, the term “heat activated adhesive” refers to an adhesive composition that is essentially non-tacky at room temperature but that becomes tacky above room temperature above an activation temperature such as above about 30° C. Heat activated adhesives typically have the properties of a pressure sensitive adhesive above the activation temperature.

Tackifying resins such as silicate tackifying resins are added to the polydiorganosiloxane polyoxamide copolymer to provide or enhance the adhesive properties of the copolymer. The silicate tackifying resin can influence the physical properties of the resulting adhesive composition. For example, as silicate tackifying resin content is increased, the glassy to rubbery transition of the adhesive composition occurs at increasingly higher temperatures. In some exemplary adhesive compositions, a plurality of silicate tackifying resins can be used to achieve desired performance.

Suitable silicate tackifying resins include those resins composed of the following structural units M (i.e., monovalent R′₃SiO_{1/2} units), D (i.e., divalent R′₂SiO_{2/2} units), T (i.e., trivalent R′SiO_{3/2} units), and Q (i.e., quaternary SiO_{4/2} units), and combinations thereof. Typical exemplary silicate resins include MQ silicate tackifying resins, MQD silicate tackifying resins, and MQT silicate tackifying resins. These silicate tackifying resins usually have a number average molecular weight in the range of 100 to 50,000 or in the range of 500 to 15,000 and generally have methyl R¹ groups.

MQ silicate tackifying resins are copolymeric resins having R′₃SiO_{1/2} units (“M” units) and SiO_{4/2} units (“Q” units), where the M units are bonded to the Q units, each of which is bonded to at least one other Q unit. Some of the SiO_{4/2} units (“Q” units) are bonded to hydroxyl radicals resulting in HOSiO_{3/2} units (“T^{OH}” units), thereby accounting for the silicon-bonded hydroxyl content of the silicate tackifying resin, and some are bonded only to other SiO_{4/2} units.

Such resins are described in, for example, Encyclopedia of Polymer Science and Engineering, vol. 15, John Wiley & Sons, New York, (1989), pp. 265-270, and U.S. Pat. No. 2,676,182 (Daudt et al.), U.S. Pat. No. 3,627,851 (Brady), U.S. Pat. No. 3,772,247 (Flannigan), and U.S. Pat. No. 5,248,739 (Schmidt et al.). Other examples are disclosed in U.S. Pat. No. 5,082,706 (Tangney). The above-described resins are generally prepared in solvent. Dried or solventless, M silicone tackifying resins can be prepared, as described in U.S. Pat. No. 5,319,040 (Wengrovius et al.), U.S. Pat. No. 5,302,685 (Tsumura et al.), and U.S. Pat. No. 4,935,484 (Wolfgruber et al.).

Certain MQ silicate tackifying resins can be prepared by the silica hydrosol capping process described in U.S. Pat. No. 2,676,182 (Daudt et al.) as modified according to U.S. Pat. No. 3,627,851 (Brady), and U.S. Pat. No. 3,772,247 (Flannigan). These modified processes often include limiting the concentration of the sodium silicate solution, and/or the silicon-to-sodium ratio in the sodium silicate, and/or the time before capping the neutralized sodium silicate solution to generally lower values than those disclosed by Daudt et al. The neutralized silica hydrosol is often stabilized with an alcohol, such as 2-propanol, and capped with R₃SiO_{1/2} siloxane units as soon as possible after being neutralized. The level of silicon bonded hydroxyl groups (i.e., silanol) on the MQ resin may be reduced to no greater than 1.5 weight percent, no greater than 1.2 weight percent, no greater than 1.0 weight percent, or no greater than 0.8 weight percent based on the weight of the silicate tackifying resin. This may be accomplished, for example, by reacting hexamethyldisilazane with the silicate tackifying resin. Such a reaction may be catalyzed, for example, with trifluoroacetic acid. Alternatively, trimethylchlorosilane or trimethylsilylacetamide may be reacted with the silicate tackifying resin, a catalyst not being necessary in this case.

MQD silicone tackifying resins are terpolymers having R′₃SiO_{1/2} units (“M” units), SiO_{4/2} units (“Q” units), and R′₂SiO_{2/2} units (“D” units) such as are taught in U.S. Pat. No. 2,736,721 (Dexter). In MQD silicone tackifying resins, some of the methyl R′ groups of the R′₂SiO_{2/2} units (“D” units) can be replaced with vinyl (CH₂═CH—) groups (“D^{Vi}” units).

MQT silicate tackifying resins are terpolymers having R′₃SiO_{1/2} units, SiO_{4/2} units and R′SiO_{3/2} units (“T” units) such as are taught in U.S. Pat. No. 5,110,890 (Butler) and Japanese Kokai HE 2-36234.

Suitable silicate tackifying resins are commercially available from sources such as Dow Corning, Midland, Mich., General Electric Silicones Waterford, N.Y. and Rhodia Silicones, Rock Hill, S.C. Examples of particularly useful MQ silicate tackifying resins include those available under the trade designations SR-545 and SR-1000, both of which are commercially available from GE Silicones, Waterford, N.Y. Such resins are generally supplied in organic solvent and may be employed in the formulations of the adhesives of the present disclosure as received. Blends of two or more silicate resins can be included in the adhesive compositions.

The tackifier is typically added to the composition to at least 10 wt. %, in some embodiments at least 30 wt. %, in some embodiments at least 40 wt. %, in some embodiments at least 50 wt. %, based on the total weight of the adhesive composition. The tackifier is typically present in composition at no greater than 70 wt. %, no greater than 65 wt. %, and in some embodiments no greater than 60 wt. % based on the total weight of the adhesive composition. In typical adhesive compositions herein, the tackifier is present in the composition at no greater than about 60 wt. % and no less than 40 wt. %. Without wishing to be bound by theory, a level of tackifier above about 60 wt. % can, in certain conditions, mean the tackifier assumes the continuous phase of the composition in favor of the silicone-containing polymer. Adhesive compositions with a tackifier forming the continuous phase tend to exhibit at least one of poor tack, poor adhesion poor shear holding strength, and insufficiently damage-free removal.

### Inorganic Filler & Other Additives

Either pressure sensitive adhesives or heat activated adhesives can be formulated by combining the silicone-containing polymers and a silicate tackifying resin with inorganic particles or other filler. The inorganic particles included in the adhesive composition tend to enhance the performance of the resulting adhesive. More particularly, the inorganic particles tend to increase the cohesive strength of the pressure-sensitive adhesive and tend to increase the rubbery plateau modulus. Surprisingly, the addition of the inorganic particles decreases the adhesive residue remaining on the substrate when the adhesive is stretched or peeled for removal after having been adhered to the substrate; reduces the peel force necessary to remove the adhesive; reduces the likelihood of damage to the adherend; and decreases the adhesion to certain release liners, all without substantially sacrificing shear strength and mounting capabilities.

The inorganic particles can be uniformly or non-uniformly distributed throughout the pressure-sensitive adhesive composition. The inorganic particles can be any suitable metal, metal alloy, metal oxide, ceramic material, or mixture thereof. The inorganic particles are often selected from, but not limited to, alumina, titania, zirconia, silica, or the like.

In many embodiments, the inorganic particles are fumed silica particles. Suitable fumed silica is commercially available, for example, under the trade designation AEROSIL (e.g., AEROSIL R972, R974, R976, R300, R380, R130, R150, R200, R202, R805, and R812) from Evonik Industries (Essen, Germany) or under the trade designation CABOSIL (e.g., CABOSIL TS-720, TS-610, TS-530, and TS-500) from Cabot (Alpharetta, Ga.). The fumed silica can have any suitable surface area. For example, the surface area can be in the range of 1 to 500 m²/gram, in the range of 10 to 400 m²/gram, or in the range of 100 to 400 m²/gram. The fumed silica can have any suitable particle size. In some applications, the fumed silica has an average primary particle size less than 30 microns, less than 15 microns, less than 10 microns, less than 5 microns, and less than 1 micron. While nanoscale fumed silica may be used in certain implementations, the use of fumed silica having an average primary particle size less than 200 nanometers may result in substrate damage. Although either hydrophobic or hydrophilic fumed silica can be used, hydrophobic fumed silica is often used because such particles tend to disperse better in the organic solvents typically included in the various compositions.

In other embodiments, the inorganic particles are aerogels such as silica aerogel particles (e.g., crushed aerogels or aerogel powder). The silica aerogel particles often have pores in the nanometer range (e.g., less than 100 nanometers or less than 50 nanometers) and have surface areas equal to at least 500 m²/gram. Exemplary aerogel silica particles can have an average particle size that is less than 20 microns or less than 10 microns. Although the size of the silica aerogel particles is larger than the wavelength of light, the particles are often translucent and can be used to form adhesive layers that are relatively clear even though they may not be considered to be optically clear. Exemplary silica aerogel particles in translucent and opacified grades are commercially available under the trade designation NANOGEL from Cabot (Billerica, Mass.).

Although the inorganic particles can be surface modified to facilitate dispersion in the silicone polymer or the adhesive composition, the inorganic particles are often not surface modified. The inorganic particles can be agglomerated or non-agglomerated and aggregated or non-aggregated. The inorganic particles can have any desired particle size or particle shape. If an optically clear adhesive article is desired, the inorganic particles are often selected to have an average particle size that is less than 1000 nanometers. For example, the average particle size is often less than 500 nanometers, less than 200 nanometers, less than 100 nanometers, or less than 50 nanometers. To prepare adhesive articles that do not need to be optically clear, larger inorganic particles can be used. For example, the inorganic particles can have an average particle size up to 5 micrometers, up to 10 micrometers, up to 20 micrometers, up to 50 micrometers, or up to 100 micrometers.

Typically, the inorganic particles will be added to a level of about 0.1% to about 20% by weight (i.e., wt-%) based upon the total weight of the adhesive composition, or any amount within that range. In presently preferred implementations the inorganic particles are added to a level of about 2% to about 15% by weight, about 3% to about 13%, and about 4% to about 10% by weight based upon the total weight of the adhesive composition, and any amounts within those specified ranges. Filler loadings below 20% by weight, particular those in the presently preferred ranges, can encourage adhesive compositions to demonstrate at least one of damage free removal, repositionability, and high shear strength, even in wet or humid environments (as demonstrated by at least the results of the Examples below). For example, a filler loading of about 4 wt-% to about 7 wt-% may be useful in high humidity and on relatively smooth surfaces like bathroom or kitchen tile. As another example, a filler loading of between about 5 wt-% and about 13 wt-% may be particularly suitable for textured or irregular surfaces (e.g., drywall). Such compositions may also demonstrate reduced adhesion to certain silicone release liners, allowing a user to quickly prepare an article for object mounting or other adhesive-related endeavor.

The adhesive compositions can further include other additives to provide desired properties. For example, dyes and pigments can be added as colorant; electrically and/or thermally conductive compounds can be added to make the adhesive electrically and/or thermally conductive or antistatic; antioxidants and antimicrobial agents can be added; and ultraviolet light stabilizers and absorbers, such as hindered amine light stabilizers (HALS), can be added to stabilize the adhesive against ultraviolet degradation and to block certain ultraviolet wavelengths from passing through the article. Other additives include, but are not limited to, adhesion promoters, additional fillers (e.g., carbon fibers, carbon black, glass beads, glass and ceramic bubbles, glass fibers, mineral fibers, clay particles, organic fibers such as nylon, metal particles, or unexpanded polymeric microspheres), tack enhancers, blowing agents, hydrocarbon plasticizers, and flame-retardants.

### Methods of Making Adhesive Compositions

In certain solvent-based processes, the silicate tackifying resin can be introduced before, during or after the polyamines and polyisocyanates have been introduced into the reaction mixture. The reaction of the polyamines and the polyisocyanate is carried out in a solvent or a mixture of solvents. The solvents are preferably nonreactive with the polyamines and polyisocyanates. The starting materials and final products preferably remain completely miscible in the solvents during and after the completion of the polymerization. These reactions can be conducted at room temperature or up to the boiling point of the reaction solvent. The reaction is preferably carried out at ambient temperature up to 50° C.

In substantially solventless processes, the polyamines and the polyisocyanate and the silicate tackifying resin are mixed in a reactor and the reactants are allowed to react to form the silicone polyurea block copolymer, which, with the tackifying resin, forms the pressure sensitive adhesive composition.

One useful method that includes a combination of a solvent-based process and a solventless process includes preparing a silicone polyurea block copolymer using a solventless process and then mixing silicone polyurea block copolymer with the silicate tackifying resin solution in a solvent. Typically, the silicone polyurea block copolymer-based pressure sensitive adhesive composition prepared according to the above-described combination method to produce a blend of silicone polyurea block copolymer and tackifying resin.

The adhesive composition can be solvent-free or can contain a solvent. Suitable solvents include, but are not limited to, toluene, tetrahydrofuran, dichloromethane, aliphatic hydrocarbons (e.g., alkanes such as hexane), or mixtures thereof.

### Adhesive Articles and Methods of Making Adhesive Articles

An adhesive article is provided that includes a substrate and an adhesive layer adjacent to at least one surface of the substrate. Other adhesive articles of the present disclosure may be backing or substrate free. Backing free adhesive constructions are described, for example, in US Publication No. 2016/0068722 (Schmitz-Stapela et al.). Some embodiments of the adhesive layer include at least one of (1) a polydiorganosiloxane polyoxamide copolymer, a silicate tackifying resin in an amount of between about 0.1 wt % and about 70 wt %, and fumed silica in between about 0.1 wt % and about 20 wt %; (2) a silicone polyurea block copolymer, a silicate tackifying resin in an amount of between about 0.1 wt % and about 70 wt %, and fumed silica in an amount between about 0.1 wt % and about 20 wt %; and (3) an addition cure silicone, a silicate tackifying resin in an amount of between about 0.1 wt % and about 70 wt %, and fumed silica in an amount between about 0.1 wt % and about 20 wt %. The substrates can include a single layer of material or can be a combination of two or more materials.

The substrates can have any useful form including, but not limited to, films, sheets, membranes, filters, nonwoven or woven fibers, hollow or solid beads, bottles, plates, tubes, rods, pipes, or wafers. The substrates can be porous or non-porous, rigid or flexible, transparent or opaque, clear or colored, and reflective or non-reflective. The substrates can have a flat or relatively flat surface or can have a texture such as wells, indentations, channels, bumps, or the like. The substrates can have a single layer or multiple layers of material. Suitable substrate materials include, for example, polymeric materials, glasses, ceramics, sapphire, metals, metal oxides, hydrated metal oxides, or combinations thereof.

Suitable polymeric substrate materials include, but are not limited to, polyolefins (e.g., polyethylene such as biaxially oriented polyethylene or high density polyethylene and polypropylene such as biaxially oriented polypropylene), polystyrenes, polyacrylates, polymethacrylates, polyacrylonitriles, polyvinyl acetates, polyvinyl alcohols, polyvinyl chlorides, polyoxymethylenes, polyesters such as polyethylene terephthalate (PET), polytetrafluoroethylene, ethylene-vinyl acetate copolymers, polycarbonates, polyamides, rayon, polyimides, polyurethanes, phenolics, polyamines, amino-epoxy resins, polyesters, silicones, cellulose based polymers, polysaccharides, nylon, neoprene rubber, or combinations thereof. Some polymeric materials are foams, woven fibers, non-woven fibers, or films.

Suitable glass and ceramic substrate materials can include, for example, silicon, aluminum, lead, boron, phosphorous, zirconium, magnesium, calcium, arsenic, gallium, titanium, copper, or combinations thereof. Glasses typically include various types of silicate containing materials.

Some substrates are release liners. The adhesive layer can be applied to a release liner and then transferred to another substrate such as a backing film or foam substrate. Suitable release liners typically contain a polymer such as polyester or polyolefin or a coated paper. Some adhesive articles transfer tape that contains an adhesive layer positioned between two release liners. Exemplary release liners include, but are not limited to, polyethylene terephthalate coated with a fluorosilicone such as that disclosed in U.S. Pat. No. 5,082,706 (Tangney) and commercially available from Loparex, Inc., Bedford Park, Ill. The liner can have a microstructure on its surface that is imparted to the adhesive to form a microstructure on the surface of the adhesive layer. The liner can be removed to provide an adhesive layer having a microstructured surface.

In some embodiments, the adhesive article is a single sided adhesive tape in which the adhesive layer is on a single major surface of a substrate such as a foam or film. In other embodiments, the adhesive article is a double-sided adhesive tape in which the adhesive layer is on two major surfaces of a substrate such as a foam or film. The two adhesive layers of the double-sided adhesive tape can be the same or different. For example, one adhesive can be a pressure sensitive adhesive and the other a heat activated adhesive where at least one of the adhesives is based on the polydiorganosiloxane polyoxamide or silicone polyurea block copolymer. Each exposed adhesive layer can be applied to another substrate.

The adhesive articles can contain additional layers such as primers, barrier coatings, metal and/or reflective layers, tie layers, and combinations thereof. The additional layers can be positioned between the substrate and the adhesive layer, adjacent the substrate opposite the adhesive layer, or adjacent to the adhesive layer opposite the substrate.

Some adhesive articles of the present disclosure have excellent shear strength. Some embodiments of the present disclosure have a shear strength of greater than 1800 minutes as measured according to ASTM D3654-82, as modified according to the Static Shear Test Method below. Some embodiments of the present disclosure have shear strength of greater than 10,000 minutes as measured according to modified ASTM D3654-82. Some embodiments of the present disclosure have shear strength of greater than 50,000 minutes as measured according to modified ASTM D3654-82.

Some adhesives that can be used in the adhesive articles of the present disclosure have a glass transition temperature of about −125° C. to 15° C., as determined by dynamic mechanical analysis of the tan 6 peak value. Some adhesives that can be used in the adhesive articles of the present disclosure have a storage modulus of about 400,000 Pa or less, or 300,000 or less at 25° C., as determined by dynamic mechanical analysis.

In some embodiments, the thickness of the adhesive on at least one of the first or second major surfaces of the multilayer carrier is about 1 μm to about 1 mm.

Some adhesive articles of the present disclosure have an elongation at break of greater than 50% in at least one direction. Some adhesive articles of the present disclosure have an elongation at break of between about 50% and about 1200% in at least one direction.

Some adhesive articles of the present disclosure have a tensile strength at break sufficiently high so that the adhesive article will not rupture prior to being removed from an adherend at an angle of 35° or less.

Some adhesive articles of the present disclosure have a lower peel force to make the adhesive article easier to remove (e.g., a force between about 25 oz/in to about 50 oz/in). Some adhesive articles of the present disclosure can have a higher peel force as to permit handling of the adhesive article by the user without accidental separation (e.g., a force between about 50 oz/in to 100 oz/in). Some embodiments of the present disclosure have a peel force between about 20 oz/in to 90 oz/in. Some embodiments of the present disclosure have a peel force between about 30 oz/in to 70 oz/in.

Some adhesive articles of the present disclosure have a tensile strength at break sufficiently high so that the adhesive article will not rupture prior to being removed from an adherend at an angle of 35° or greater.

A method of making an adhesive article typically includes providing a substrate and applying an adhesive composition to at least one surface of the substrate. The adhesive composition can be applied to the substrate by a wide range of processes such as, for example, solution coating, solution spraying, hot melt coating, extrusion, coextrusion, lamination, and pattern coating. The adhesive composition is often applied as an adhesive layer to a surface of substrate with a coating weight of 0.02 grams/154.8 cm² to 2.4 grams/154.8 cm².

The adhesive articles of the disclosure may be exposed to post processing steps such as curing, crosslinking, die cutting, heating to cause expansion of the article, e.g., foam-in-place, and the like.

### Hardgoods

Some embodiments of adhesive articles described herein further include a hardgood or mounting device. Exemplary hardgoods or mounting devices include, for example, hooks, knobs, clips, and loops. In some embodiments the hardgood resembles a nail. In some embodiments the hardgood has a single outward projection to act as a hanging surface. In some embodiments the hardgood has multiple outward projections to act as a hanging surface. In some embodiments, the hardgood has is molded into a shape that can hold one or more items within such as but not limited to a box or caddy. In some embodiments, the hardgood is a shelf, ledge, or rack. In some embodiments, the hardgood is a bar wherein the bar can be straight or curved or substantially a ring wherein the bar can be mounted parallel or normal to the substrate surface. In some embodiments, the hardgood uses multiple methods for mounting or hanging items. Any of the following mounting devices can be used with the adhesive article of the present disclosure: Application Matter No. 77486US002 (assigned to the present assignee), U.S. Pat. No. 5,409,189 (Luhmann), U.S. Pat. No. 5,989,708 (Kreckel), U.S. Pat. No. 8,708,305 (McGreevy), U.S. Pat. No. 5,507,464 (Hamerski et al.), U.S. Pat. No. 5,967,474 (doCanto et al.), U.S. Pat. No. 6,082,686 (Schumann), U.S. Pat. No. 6,131,864 (Schumann), U.S. Pat. No. 6,811,126 (Johansson, et al.), U.S. Pat. No. D665,653, and U.S. Pat. No. 7,028,958 (Pitzen, et al.), all of which are incorporated by reference in their entirety herein. The hardgood may be any object to be mounted to a substrate.

In some embodiments, the hardgood is mounted to the substrate in one or more places wherein one or more of the mounting locations contain a removable adhesive portion featuring one or more of the adhesive compositions described herein. In some embodiments, the hardgood is mounted using a combination of removable adhesive portions and conventional mechanical fasteners including but not limited to nails, screws, bolts, and rivets.

In some embodiments, the hardgood is made from of thermoplastic polymers. In some embodiments, the hardgood is made from thermoset polymers. In some embodiments, the hardgood is made using polyolefin materials. In some embodiments, the hardgood is made using polycarbonate materials. In some embodiments, the hardgood is made using high-impact polystyrene. In some embodiments, the hardgood is made using acrylonitrile-butadiene-styrene (ABS) terpolymers. In some embodiments, the hardgood is made using two or more polymeric materials. In some embodiments, the hardgood is made from metal. In some embodiments, the hardgood is made from stainless steel. In some embodiments, the metal is painted, glazed, stained, brushed, or coated to alter its appearance. In some embodiments the hardgood is made from ceramic. In some embodiments, the hardgood is made from glazed ceramic. In some embodiments, the hardgood is made from unglazed ceramic. In some embodiments, the hardgood is comprised of naturally-based materials such as wood, bamboo, particle board, cloth, canvas, or derived from biological sources, and the like. In some embodiments, the naturally-based materials may be painted, glazed, stained, or coated to change their appearance. In some embodiments, the hardgood is made using two or more materials from the list above. In some embodiments, the hardgood is made from two pieces that are reversibly or irreversibly attached, joined, or welded together.

In some embodiments, the hardgood comprises two pieces wherein the first piece acts as a mounting surface for attaching the compliant and removable layers to a substrate, and the second piece acts as a hanging member which may be used for hanging or mounting objects to the substrate. The two pieces may be reversibly attached using mechanical fasteners, hook and loop materials, or an additional adhesive layer.

The hardgood can be made using any method previously known in the art. In some embodiments, the removable adhesive may be attached to the hardgood using a lamination process. In some embodiments, the removable adhesive (and substrate, if present) may be attached to the hardgood using multiple lamination processes.

In some embodiments, the removable adhesive may be attached to the hardgood using two or more injection molding steps in using one or more molds.

In some embodiments, the removable adhesive may be attached manually by the end user.

In some embodiments, the adhesive article can further include a separable connector. Some exemplary separable connectors are described in, for example, U.S. Pat. Nos. 6,572,945; 7,781,056; 6,403,206; and 6,972,141, all of which are incorporated by reference in their entirety herein.

### Methods of Using the Adhesive Articles Described Herein

The articles of the present disclosure can be used in various ways. In some embodiments, the adhesive article is applied, attached to, or pressed into an adherend. In this way, the adhesive article contacts the adherend. Where a release liner is present, the release liner is removed before the adhesive article is applied, attached to, or pressed into an adherend. In some embodiments, at least a portion of the adherend is wiped with alcohol before the adhesive article is applied, attached to, or pressed into an adherend.

The adhesive articles may be used in wet or high humidity environments such as those found in bathrooms. For example, they can be adhered to toilets (e.g., toilet tanks), bathtubs, sinks, and walls. The adhesive article may be used in showers, locker rooms, steam rooms, pools, hot tubs, and kitchens (e.g., kitchen sinks, dishwashers and back splash areas, refrigerators and coolers). The adhesive article may also be used in low temperatures applications including outdoor applications and refrigerators. Useful outdoor applications include bonding articles such as signage to outdoor surfaces such as windows, doors and vehicles.

The adhesive article (i.e., those in adhesive tapes or single article) can be provided in any useful form including, e.g., tape, strip, sheet (e.g., perforated sheet), label, roll, web, disc, and kit (e.g., an object for mounting and the adhesive tape used to mount the object). Likewise, multiple adhesive articles can be provided in any suitable form including, e.g., tape, strip, sheet (e.g., perforated sheet), label, roll, web, disc, kit, stack, tablet, and combinations thereof in any suitable package including, for example, dispenser, bag, box, and carton.

To remove the adhesive article from the adherend, at least a portion of the adhesive article is peeled or stretched away from the adherend. In some embodiments, the angle of stretch is 35 or less. In embodiments where a tab is present, the user can grip the tab and use it to release or remove the adhesive article from the adherend.

The adhesive articles may be used to mount various items and objects to surfaces such as painted drywall, plaster, concrete, glass, ceramic, fiberglass, metal or plastic. Items that can be mounted include, but are not limited to, wall hangings, organizers, holders, baskets, containers, anti-slip mats, decorations (e.g., holiday decorations), calendars, posters, dispensers, wire clips, body side molding on vehicles, carrying handles, signage applications such as road signs, vehicle markings, transportation markings, and reflective sheeting.

The foregoing describes the disclosure in terms of embodiments foreseen by the inventor for which an enabling description was available, notwithstanding that insubstantial modifications of the disclosure, not presently foreseen, may nonetheless represent equivalents thereto.

### EXAMPLES

These examples are merely for illustrative purposes only and are not meant to be limiting on the scope of the appended claims. All parts, percentages, ratios, etc. in the examples and the rest of the specification are by weight, unless noted otherwise.

### Test Methods

### Test Methods

### 90° Angle Peel Adhesion Strength Test

The peel adhesion strength and removability were evaluated by the following method. Test strips (multi-layer composite tapes as described below) were applied to adherends by rolling down with a 15 lb. roller. Adhered samples were aged at 72° F. (22° C.) and 50% RH (CTH) conditions for at least a 1 hour dwell time before testing. The strips were peeled from the panel using an INSTRON universal testing machine with a crosshead speed of 12 in/min (30.5 cm/min), unless otherwise indicated (some samples were run at 90 in/min (228.6 cm/min)). The peel force was measured and the panels were observed to see if visible adhesive residue remained on the panel or if any damage had occurred. The peel data in the Tables represent an average of three tests.

Peel damage code—To study the effect of peel adhesion on drywall damage the following qualitative coding system was assigned to different levels of damage:

| Damage Code | Description |
|---|---|
| 1 | Small paint blisters |
| 2 | Large paint blisters |
| 3 | Paint blister across the whole peeled |
| | area plus small paint rip off |
| 4 | Paint rip off of less than 50% of peel area |
| 5 | Total paint damage/rip off |

### Shear Strength Test

Shear strength was determined according to the ASTM D-3654-82 method. Test squares (multi-layer composite tapes as described below) were applied to adherends and a 0.5 in or 0.75 in wide by approximately 4 in long (1.27 cm or 1.91 cm wide by 10.16 cm long) metalized PET film was attached to the opposing (non-peelable) adhesive. The metallized PET was doubled back on itself and stapled. The samples were subsequently rolled down with two passes using a 15 lb. roller. The samples were mounted in a vertical position and allowed to dwell for 60 minutes at CTH conditions (unless otherwise specified) before attaching either a 750 gram or 1000 gram load to the adhesive. Samples were hung until failure or until at least 25,000 minutes had elapsed (note that 10,000 minutes is the ASTM time limit).

### Package Weight Claim Test

Multi-layer composite tape samples were prepared with a DUAL LOCK strip backing as described below. Test samples were cut into 0.75 in×0.75 in (1.91 cm×1.91 cm) squares. Each sample was used in pairs for each test. For each pair, one was applied to the painted drywall by sticking the silicone adhesive side to the drywall so that the DUAL LOCK backing was facing out. The second piece was applied to a 1 in×2 in (2.54 cm×5.08 cm) aluminum panel from the silicone adhesive side such that the DUAL LOCK backing was facing out as well. A 15.4 lb roller was used to apply consistent pressure with 12 in/min speed (two passes) to the piece applied to the drywall to achieve proper wet out. The two pieces (one on the drywall and the other one on aluminum panel) were married by fastening the DUAL LOCK sides to each other. The samples were mounted in a vertical position and allowed to dwell on the test substrate for 60 minutes at specific conditions (either CTH or 72° F./75% RH). After one hour dwell time was up, a 1000 gram weight was applied to the samples by hanging the weight onto the aluminum panel. Failure was indicated when it was observed that adhesive squares completely fell off the test substrate (the adhesive no longer adhered to the test substrate surface). The Package Weight Claim data in the Tables is provided as Weight Holding Power (days). The data are an average of 3 tests.

Some package weight testing was performed with medium size Command™ Utility hook (strip size: 5/8″×2″, available from 3M Company) on FEN in 72° F./75% RH condition.

Also some package weight testing was carried out in a shower spray chamber at 95% RH using a continuous H₂O spray with a water temperature of 105° F.-120° F. (41° C.-49° C.). Medium size Command™ Utility hook (strip size: 5/8″×2″, available from 3M Company) were used in this test. Samples were adhered to White Glazed Ceramic Wall Tile (Interceramic, Carollton, Tex.), and the load on the samples was 3 lbs.

### Liner Peel Release Test

Samples were tested at CTH conditions.

### Easy Side:

A 2.54 cm wide and approximately 20 cm long sample of the adhesive transfer tape on liner was cut using a specimen razor cutter. At least 4 transfer adhesive tapes prepared as described below were laid down on top of each other such that the adhesive side on each strip was brought in contact with the liner side of the next strip. The stack of at least two strips was applied lengthwise onto the platen surface of a peel adhesion tester (an IMASS SP-2100 tester, obtained from IMASS, Inc., Accord, Mass.) using 3M Double Coated Paper Tape 410M (available from 3M Company, St. Paul, Minn., USA). The top strip was peeled from the liner underneath at an angle of 180 degrees at, e.g., 60 in/min (152.4 cm/min). The average force required to peel three strips from their underneath counterparts was recorded as the easy side liner release.

### Tight Side:

A 2.54 cm wide and approximately 20 cm long sample of the adhesive transfer tape on liner was cut using a specimen razor cutter. The cut sample was applied lengthwise onto the platen surface of a peel adhesion tester (an IMASS SP-2100 tester, obtained from IMASS, Inc., Accord, Mass.) using 3M Double Coated Paper Tape 410M (available from 3M Company, St. Paul, Minn., USA). The release liner was peeled from the adhesive at an angle of 180 degrees at, e.g., 12 in/min (30.5 cm/min). The average force required to peel three liners from the adhesives was recorded as the tight side liner release.

### Rheology Measurements

Rheological properties were conducted in torsion mode using a Dynamic Mechanical Analyzer Discovery HR-3 (TA Instruments, New Castle, Del.) equipped with 8 mm parallel plate grips. Samples were prepared by folding the PSA four times to bring the thickness of the adhesive to roughly about 1 mm. Samples were cut to 8 mm diameter disks using a punch cutter made specifically for that purpose.

An initial static axial force of 50-300 gr was applied in the compression mode during the test to make sure the adhesive is under proper force during the test. Strain Adjustment of 50% was always left in enabled mode so that the sample was never subjected to axial-mode deformations during the experiment. Temperature was controlled using a nitrogen-purged force convection oven. A special liquid nitrogen Dewar, supplied by TA Instruments was used to achieve sub-ambient temperatures. The sample was loaded at an initial test temperature of 25° C., and during the experiment the temperature was stepped downward in 3° C. increments to a final temperature of −65° C. At each temperature step, the sample was subjected to torsion oscillations at 1 rad/s frequency with a strain of 5%. Results were plotted as a function of temperature. Shear storage modulus (G′), loss modulus (G″) and tan delta (defined as the value of the ratio of (loss modulus/storage modulus) (G″/G′)) were reported at specific temperatures such as 25° C.

### Test Adherends

Drywall panels (obtained from Materials Company, Metzger Building, St. Paul, Minn.) were painted with Behr PREMIUM PLUS ULTRA® Primer and Paint 2 in 1 Flat Egyptian Nile (FEN) obtained from Behr Process Corporation, Santa Ana, Calif.) or Sherwin-Williams DURATION®, Interior Acrylic Latex Ben Bone White Paint SWBB) obtained from Sherwin-Williams Company, Cleveland, Ohio). A third paint used for peel adhesion testing was a Clark+Kensington Semi-Gloss Acrylic Latex, Paint and Primer Designer White (CS), obtained at Ace Hardware.

Procedure for painting: a first coat of paint was applied to a panel using a paint roller, followed by air drying for 24 hours at ambient conditions. A second coat of paint was applied and dried at ambient conditions for 24 hours. The panel was placed in a forced air oven set to 50° C. for 7 days. Then the panel was then stored at ambient conditions until use.

Panels of glass and painted drywall measuring 2 in×2 in (5.1 cm×5.1 cm) were used for Shear Strength testing. Panels of glass and painted drywall measuring 6 in×12 in (15.2 cm×30.5 cm) were used for Peel Adhesion and Package Weight Claim testing at 72° F./75RH %.

### Preparation of Adhesive Transfer Tapes

Pressure sensitive adhesive compositions were knife-coated onto a paper liner web having a fluoroalkyl silicone release surface. The paper liner web speed was 2.75 meter/min. After coating, the web was passed through an oven 11 meters long (residence time 4 minutes total) having three temperature zones. The temperature in zone 1 (2.75 meter) was 57° C.; temperature in zone 2 (2.75 meter) was 80° C.; temperature in zone 3 (about 5.5 meter) was 93° C. The caliper of the dried adhesive was approximately 2.5-3.0 mils thick. The adhesive transfer adhesive tapes were then stored at ambient conditions.

Addition cure examples were coated using a manual handspread coater. The same caliper was applied to achieve 2.5-3.0 mils thick dry adhesive. After coating the adhesives were cured in a convection oven for 3 minutes at 120° C.

### Multi-Layer Composite Tape Preparation

The transfer adhesives were then laminated to film-foam-film composites and the desired size and geometry was die cut. In specific, the test adhesive composition was adhered to the first side of a composite film-foam-film construction like that found on COMMAND strip products (31 mil 6 lb. foam with 1.8 mil polyethylene film on both sides of the foam). This side of the film-foam-film construction was primed with 3M Adhesion Promoter 4298UV (3M Company, St. Paul, Minn.) prior to adhesive lamination. The second side of the composite foam had a second non-peelable adhesive adhered along the entire width and length of the test sample. A 3M DUAL LOCK strip backing, or a 2 mil PET film was adhered to the second side for peel adhesion testing and package weight claim testing, or a metalized PET film was adhered to the second side for shear testing. Samples of the adhesive coated film-foam-film composites were die cut into 1 in wide×6 in long strips (2.54 cm×15.24 cm) for peel testing from painted drywall, or 0.5 in×0.5 in (1.27 cm×1.27 cm) for shear testing, or 0.75 in×0.75 in (1.91 cm×1.91 cm) for package weight claim testing.

### Preparation of Surface Modified Fumed Silica

To a glass bottle was added 250 g of Cab-O-Sperse 2017A (available from Cabot Corp., Alpharetta, Ga., USA as an approximately 17% solids silica dispersion in water). With magnetic stirring, 250 g of isopropanol was added slowly. To this mixture was added 10.29 g of hexadecyl trimethoxy silane (available from Wacker Chemical Corp., Adrian, Mich., USA as Silane 25013VP) and 0.45 g of methyl trimethoxy silane (available from Wacker Chemical Corp., Adrian, Mich., USA as Silane M1-Trimethoxy). The bottle was sealed tightly with a cap and the combined mixture was heated and agitated in a water bath at 80 C for 24 hours. After cooling to room temperature, the contents were transferred to a flask using toluene to rinse. The water and isopropanol were removed on a rotary evaporator, periodically replacing the volume with additional toluene until the resulting dispersion was 16.5% solids in toluene.

### Examples E1-E12 and Comparative Examples CE1-CE4

### Silicone Polyurea Block Copolymer Pressure Sensitive Adhesive Formulations

Fumed silica (AEROSIL R 812 S, available from Evonik Corporation, Parsippany, N.J.) was added to a tared, 32 ounce jar and was diluted with toluene and MQ tackifier resin (SR545, supplied as a 30 wt % solids solution in toluene, available from Momentive Performance Materials, Watertown, N.Y.). The resulting mixture was subjected to a paint shaker, set to high, for 15 minutes which produced a thick, iridescent dispersion. An elastomeric solution of a silicone polyurea block copolymer (in 65/35 toluene/isopropyl alcohol) was then added to the jar, sealed, and mixed by placing the jar on a roller for 18 hours set to approximately 25 rpm. The silicone polyurea block copolymer (SPU) was the same as the silicone polyurea block copolymer used to prepare the pressure sensitive adhesive composition of Example 28 in U.S. Pat. No. 6,569,521. Adhesive transfer tapes and multi-layer composite tapes were prepared as described above. The pressure sensitive adhesive formulations and percent solids used for coating are provided in Table 1. Rheological properties of the pressure sensitive adhesives are provided in Table 2.

TABLE 1
Adhesive Formulations

| | MQ Resin | Fumed Silica | SPU | |
|---|---|---|---|---|
| Example | (wt %) | (wt %) | (wt %) | % Solids |
| CE1 | 30 | 0 | 70 | 25 |
| CE2 | 40 | 0 | 60 | 25 |
| CE3 | 50 | 0 | 50 | 25 |
| CE4 | 60 | 0 | 40 | 25 |
| E1 | 30 | 3 | 67 | 21 |
| E2 | 40 | 3 | 57 | 25 |
| E3 | 50 | 3 | 47 | 25 |
| E4 | 60 | 3 | 37 | 25 |
| E5 | 30 | 6 | 64 | 20 |
| E6 | 40 | 6 | 54 | 21 |
| E7 | 50 | 6 | 44 | 21 |
| E8 | 60 | 6 | 34 | 25 |
| E9 | 30 | 9 | 61 | 19 |
| E10 | 40 | 9 | 51 | 20 |
| E11 | 50 | 9 | 41 | 20 |
| E12 | 60 | 9 | 31 | 21 |

TABLE 2
Rheological Properties at 25° C.

| | Storage | Loss | |
|---|---|---|---|
| Example | Modulus (Pa) | Modulus (Pa) | Tan δ |
| CE1 | 122214 | 7508 | 0.06 |
| CE2 | 114636 | 15588 | 0.14 |
| CE3 | 143742 | 48697 | 0.34 |
| E1 | 194905 | 14564 | 0.07 |
| E2 | 196144 | 27712 | 0.14 |
| E3 | 309366 | 97471 | 0.32 |
| E5 | 277756 | 21302 | 0.08 |
| E6 | 364205 | 50193 | 0.14 |
| E7 | 478760 | 136762 | 0.29 |
| E9 | 410910 | 37629 | 0.09 |
| E10 | 472515 | 71331 | 0.15 |
| E11 | 800345 | 239273 | 0.30 |

TABLE 3
90° Angle Peel Adhesion

| | Average of Actual Avg Load (oz/in) | | | | Average of Max Load (oz/in) | | | |
|---|---|---|---|---|---|---|---|---|
| | SWBB | | | | SWBB | | | |
| Example | 1 hour | 1 week | 1 month | 3 months | 1 hour | 1 week | 1 month | 3 months |
| CE1 | 22.85 | 21.10 | 18.33 | 21.35 | 45.60 | 56.51 | 56.72 | 49.55 |
| CE2 | 22.37 | 23.09 | 19.52 | 18.75 | 54.76 | 59.98 | 62.25 | 59.95 |
| CE3 | 21.18 | 22.50 | 19.81 | 18.91 | 47.30 | 60.07 | 60.99 | 57.76 |
| CE4 | 27.43 | 33.74 | 30.90 | 23.73 | 37.74 | 42.52 | 50.55 | 46.87 |
| El | 23.53 | 35.06 | 20.65 | 20.83 | 36.53 | 42.18 | 29.69 | 42.06 |
| E2 | 22.27 | 21.835 | 20.66 | 24.34 | 40.82 | 49.59 | 48.86 | 28.26 |
| E3 | 22.74 | 29.20 | 22.30 | 24.47 | 38.56 | 46.95 | 41.82 | 35.31 |
| E4 | 8.18 | 10.20 | 11.40 | 12.87 | 14.76 | 12.80 | 15.68 | 17.21 |
| E5 | 16.13 | 19.64 | 16.84 | 17.36 | 18.79 | 23.51 | 20.56 | 22.03 |
| E6 | 14.84 | 19.51 | 19.45 | 14.65 | 17.63 | 26.26 | 24.61 | 21.32 |
| E7 | 16.03 | 16.59 | 14.91 | 15.46 | 24.01 | 21.40 | 21.56 | 21.46 |
| E8 | 2.77 | 3.25 | 5.08 | 5.37 | 3.94 | 4.63 | 9.14 | 6.625 |
| E9 | 10.37 | 10.73 | 10.78 | 10.57 | 12.65 | 17.04 | 16.02 | 15.19 |
| E10 | 8.32 | 9.09 | 9.77 | 8.20 | 10.93 | 12.80 | 15.91 | 13.52 |
| E11 | 7.63 | 10.71 | 8.17 | 7.78 | 11.04 | 16.21 | 11.35 | 10.45 |
| E12 | 0.30 | 0.14 | 0.14 | 1.36 | 0.71 | 0.43 | 0.81 | 2.62 |

TABLE 4
Average of Damage Code
Average of Damage Code

| | SWBB | | | |
|---|---|---|---|---|
| Example | 1 hour | 1 week | 1 month | 3 months |
| CE1 | 5 | 5 | 5 | 5 |
| CE2 | 5 | 5 | 5 | 5 |
| CE3 | 5 | 5 | 5 | 5 |
| CE4 | −1 | 2 | 3.5 | 5 |
| E1 | 5 | 2 | 2.5 | 5 |
| E2 | 2 | 5 | 5 | 0 |
| E3 | 5 | 4.5 | 5 | 5 |
| E4 | −1 | 0 | −0.5 | 0 |
| E5 | 0 | 0 | 0 | 0 |
| E6 | 0 | 0.5 | 0 | 0 |
| E7 | 0.5 | 0 | 0 | 0 |
| E8 | 0 | 0 | 0 | 0 |
| E9 | 0 | 0 | 0 | 0 |
| E10 | 0 | 0 | 0 | 0 |
| E11 | 0 | 0 | 0 | 0 |
| E12 | 0 | 0 | 0 | 0 |

* Negative Damage Codes are a sign of 2-bond failures which is the failure between the adhesive and backing.

TABLE 5
90° Angle Peel Adhesion

| | Average of Actual Avg Load | | | Average of Actual Max Load | | |
|---|---|---|---|---|---|---|
| | (oz/in) | | | (oz/in) | | |
| | Glass | | | Glass | | |
| Example | 1 hour | 1 week | 1 month | 1 hour | 1 week | 1 month |
| CE1 | 9.37 | 23.61 | 58.99 | 10.69 | 27.19 | 77.60 |
| CE2 | 16.31 | 40.87 | 51.88 | 18.47 | 48.48 | 64.82 |
| CE3 | 43.91 | 45.76 | 56.40 | 48.28 | 56.74 | 63.71 |
| CE4 | 92.66 | 71.72 | 89.48 | 112.90 | 81.74 | 96.59 |
| El | 8.40 | 33.52 | 36.60 | 9.380 | 39.54 | 45.89 |
| E2 | 20.64 | 28.34 | 32.78 | 25.44 | 34.48 | 38.47 |
| E3 | 24.03 | 33.14 | 34.53 | 25.71 | 35.35 | 36.66 |
| E4 | 71.74 | 99.43 | 114.18 | 98.68 | 116.85 | 132.64 |
| E5 | 9.65 | 28.69 | 34.36 | 11.22 | 34.17 | 39.32 |
| E6 | 13.37 | 21.19 | 25.60 | 21.67 | 26.33 | 30.54 |
| E7 | 17.96 | 22.04 | 24.96 | 21.37 | 27.63 | 29.97 |
| E8 | 24.66 | 18.70 | 29.15 | 33.81 | 49.53 | 47.70 |
| E9 | 8.08 | 21.33 | 22.62 | 11.97 | 25.13 | 27.81 |
| E10 | 9.83 | 16.23 | 14.70 | 13.15 | 20.39 | 23.82 |
| E11 | 8.00 | 14.88 | 18.28 | 14.96 | 23.47 | 29.06 |
| E12 | 9.43 | 18.40 | 23.04 | 19.97 | 26.33 | 34.16 |

TABLE 6
Shear Strength

| | Shear Holding Time | | | Shear Holding Time | | |
|---|---|---|---|---|---|---|
| | (minutes) 6.6 lbs/in² | | | (minutes) 8.8 lbs/in² | | |
| Example | FEN | Glass | SWBB | FEN | Glass | SWBB |
| CE1 | >80000 | NT | >80000 | >47000 | >60500 | >70000 |
| CE2 | >80000 | NT | >80000 | >70600 | >60500 | >70000 |
| CE3 | >80000 | NT | >80000 | >70600 | >60500 | >70000 |
| CE4 | >80000 | NT | >80000 | 2800 | >60500 | 6459 |
| El | >80000 | NT | >80000 | >70600 | >60500 | >70000 |
| E2 | >80000 | NT | >80000 | >70600 | >60500 | >70000 |
| E3 | >80000 | NT | >80000 | >70600 | >60500 | >70000 |
| E4 | >80000 | NT | >80000 | 16000 | >60500 | 15780 |
| E5 | >80000 | NT | >80000 | >70600 | >60500 | >70000 |
| E6 | >80000 | NT | >80000 | >70600 | >60500 | >70000 |
| E7 | >80000 | NT | >80000 | >60500 | >60500 | >70000 |
| E8 | 649 | NT | >80000 | 98 | >60500 | 282 |
| E9 | >80000 | NT | >80000 | >70600 | >60500 | >70000 |
| E10 | >80000 | NT | >80000 | >70600 | >60500 | >70000 |
| E11 | >80000 | NT | >80000 | 47000 | >60500 | >70000 |
| E12 | 1 | NT | 350 | <1 | >60500 | 6 |

NT = not tested

TABLE 7
Shear Strength (72° F./75% RH)

| | Shear Holding Time (Days) |
|---|---|
| Example | FEN |
| CE1 | 1 |
| CE2 | 1 |
| CE3 | 14 |
| CE4 | 1 |
| E1 | 1 |
| E2 | 11 |
| E3 | 13 |
| E4 | 9 |
| E5 | 2.5 |
| E6 | 1 |
| E7 | 15 |
| E8 | 1 |
| E9 | 2.5 |
| E10 | 1 |
| E11 | 18.5 |
| E12 | 1 |

TABLE 8
Package Weight Claim (shower chamber)

| Example | Shear Holding Time (Days) |
|---|---|
| CE1 | NT |
| CE2 | 18 |
| CE3 | 0 |
| CE4 | NT |
| E1 | NT |
| E2 | 0 |
| E3 | 18 |
| E4 | NT |
| E5 | NT |
| E6 | 0 |
| E7 | 18 |
| E8 | NT |
| E9 | NT |
| E10 | 12 |
| E11 | 18 |
| E12 | NT |
| CE5* | 18 |

*CE5 includes the pressure sensitive adhesive composition of Example 28 in U.S. Pat. No. 6,569,521.

TABLE 9
Shear Strength (DUAL LOCK construction)

| | Shear Holding Time (minutes) | |
|---|---|---|
| | 8.8 lbs/in² | |
| Example | CTH | 72° F./75% RH |
| CE1 | 15833 | NT |
| CE2 | NT | NT |
| CE3 | 34773 | 30240 |
| CE4 | 30912 | NT |
| E1 | 10542 | NT |
| E2 | 31866 | 10944 |
| E3 | 23356 | 30240 |
| E4 | 29471 | NT |
| E5 | 22655 | NT |
| E6 | 12447 | 1440 |
| E7 | 20195 | 30240 |
| E8 | 15815 | NT |
| E9 | 31625 | NT |
| E10 | 26616 | 10944 |
| E11 | 32388 | 13968 |
| E12 | 16 | NT |

TABLE 10
Liner Peel Release

| | Liner Peel Release (grams/inch) | |
|---|---|---|
| Example | Easy | Tight |
| CE1 | 1.3 | 272.0 |
| CE2 | 1.3 | 503.7 |
| CE3 | NT | NT |
| CE4 | 2.7 | 65.3 |
| E1 | 1.3 | 69.0 |
| E2 | NT | NT |
| E3 | 1.3 | 174.7 |
| E4 | 0.7 | 29.0 |
| E5 | 1.0 | 40.7 |
| E6 | 1.0 | 51.7 |
| E7 | 1.0 | 78.0 |
| E8 | 1.7 | 29.0 |
| E9 | 1.0 | 30.0 |

### Examples E13-E22

The pressure sensitive adhesive formulations for Examples E13-E-22 were prepared following the general procedure described for Examples E1-E12. Adhesive transfer tapes and multi-layer composite tapes were prepared as described above. The pressure sensitive adhesive formulations and percent solids used for coating are provided in Table 11. Rheological properties of the pressure sensitive adhesives are provided in Table 12.

TABLE 11
Adhesive Formulations

| | MQ Resin | Fumed Silica | SPU | |
|---|---|---|---|---|
| Example | (wt %) | (wt %) | (wt %) | % Solids |
| E13 | 40 | 12 | 48 | 21 |
| E14 | 45 | 12 | 43 | 21 |
| E15 | 50 | 12 | 38 | 21 |
| E16 | 40 | 16 | 44 | 20 |
| E17 | 45 | 16 | 39 | 21 |
| E18 | 50 | 16 | 34 | 20 |
| E19 | 40 | 20 | 40 | 20 |
| E20 | 45 | 20 | 35 | 20 |
| E21 | 50 | 20 | 30 | 21 |
| E22 | 45 | 12 | 43 | 19 |

TABLE 12
Rheological Properties at 25° C.

| | Storage | Loss | |
|---|---|---|---|
| Example | Modulus (Pa) | Modulus (Pa) | Tan δ |
| E13 | 590369 | 89635 | 0.15 |
| E14 | 737319 | 143930 | 0.20 |
| E15 | 943647 | 256667 | 0.27 |
| E17 | 1409980 | 363340 | 0.26 |
| E18 | 2040490 | 702778 | 0.34 |
| E20 | 2622320 | 845004 | 0.32 |
| E21 | 3478700 | 1459050 | 0.42 |
| E22 | 706144 | 127662 | 0.18 |

TABLE 13
90° Angle Peel Adhesion

| | Average of Actual Avg Load (oz/in) | | | | | |
|---|---|---|---|---|---|---|
| | SWBB | | | CS | | |
| Example | 1 hour | 1 week | 1 month | 1 hour | 1 week | 1 month |
| E13 | 5.10 | 6.65 | 6.65 | 6.64 | 8.03 | 9.20 |
| E14 | 4.80 | 4.96 | 5.76 | 6.94 | 8.50 | 9.30 |
| E15 | 1.72 | 3.18 | 5.11 | 6.68 | 7.38 | 8.43 |
| E16 | 1.16 | 1.43 | 2.89 | 4.02 | 4.87 | 6.71 |
| E17 | 1.16 | 0.97 | 1.32 | 3.91 | 5.54 | 6.59 |
| E18 | 0.23 | 0.48 | 0.70 | 3.88 | 4.61 | 6.21 |
| E19 | 0.15 | 0.20 | 0.360 | 2.62 | 4.16 | 5.12 |
| E20 | 0 | 0.38 | 0.27 | 2.16 | 3.02 | 4.39 |
| E21 | 0 | 0.12 | 0.04 | 1.73 | 2.41 | 2.28 |
| E22 | 4.17 | 5.37 | 5.21 | 5.30 | 6.96 | 7.07 |

TABLE 14
90 °Angle Peel Adhesion

| | Average of Actual Avg Load (oz/in) | | |
|---|---|---|---|
| | SWBB | | |
| | 1 hour dwell time | | |
| Example | 1 in/min | 12 in/min | 90 in/min |
| E13 | 4.87 | 5.34 | 5.92 |
| E14 | 3.46 | 4.21 | 5.33 |
| E15 | 2.67 | 3.02 | 3.48 |
| E16 | 1.06 | 1.93 | 1.20 |
| E17 | 1.21 | 1.87 | 1.74 |
| E18 | 1.53 | 1.17 | 1.43 |
| E19 | 0.85 | 1.26 | 0.86 |
| E20 | 0.75 | 0.85 | 0.48 |
| E21 | 0.59 | 0.82 | 0.84 |
| E22 | 1.65 | 3.90 | 3.91 |

TABLE 15
Shear Strength

| | Shear Holding Time (minutes) | |
|---|---|---|
| | 8.8 lbs/in² | |
| Example | FEN | Glass |
| E13 | >38000 | >38000 |
| E14 | 18319 | >38000 |
| E15 | >38000 | >38000 |
| E16 | 399 | >38000 |
| E17 | 144 | >38000 |
| E18 | 0 | >38000 |
| E19 | 0 | >38000 |
| E20 | 0 | 445 |
| E21 | 0.3 | 0.6 |
| E22 | >29990 | >38000 |

TABLE 16
Shear Strength (DUAL LOCK construction,
72° F./75% RH)

| | Shear Holding Time (days) |
|---|---|
| Example | 8.8 lbs/in² |
| E13 | 14.3 |
| E14 | 7.7 |
| E15 | 9.7 |
| E16 | NT |
| E17 | NT |
| E18 | NT |
| E19 | NT |
| E20 | NT |
| E21 | NT |
| E22 | NT |

### Examples E23-E26

The pressure sensitive adhesive formulations for Examples E23-E26 were prepared following the general procedure described for Examples E-E12, except CABOSIL TS-382 (available from Cabot Corporation, Boston, Mass.) was the fumed silica used for Examples E24 and E26, instead of AEROSIL R 812 S. Adhesive transfer tapes and multi-layer composite tapes were prepared as described above. The pressure sensitive adhesive formulations and percent solids used for coating are provided in Table 17. Rheological properties of the pressure sensitive adhesives are provided in Table 18.

TABLE 17
Adhesive Formulations

| | MQ Resin | Fumed Silica | SPU | |
|---|---|---|---|---|
| Example | (wt %) | (wt %) | (wt %) | % Solids |
| E23 | 50 | 9 | 41 | 24 |
| E24 | 50 | 9 | 41 | 24 |
| E25 | 50 | 12 | 38 | 24 |
| E26 | 50 | 12 | 38 | 24 |

TABLE 18
Rheological Properties at 25° C.

| | Storage | Loss | |
|---|---|---|---|
| Example | Modulus (Pa) | Modulus (Pa) | Tan δ |
| E23 | 471518 | 136856 | 0.29 |
| E24 | 447203 | 106226 | 0.22 |
| E25 | 923433 | 278735 | 0.30 |
| E26 | 651757 | 175510 | 0.27 |

TABLE 19
90° Angle Peel adhesion (with DUAL LOCK strip backing)

| | Average of Actual Avg Load (oz/in) | | | | Average of Max Load (oz/in) | | | |
|---|---|---|---|---|---|---|---|---|
| | SWBB | | | | SWBB | | | |
| Example | 1 hour | 1 week | 1 month | 3 months | 1 hour | 1 week | 1 month | 3 months |
| E23 | 3.09 | 4.63 | 4.07 | 4.68 | 5.5 | 7.01 | 8.36 | 5.97 |
| E24 | 2.27 | 3.18 | 3.02 | 3.25 | 4.22 | 4.33 | 4.81 | 4.63 |
| E25 | 1.14 | 1.90 | 1.60 | 1.28 | 1.51 | 2.70 | 2.20 | 1.83 |
| E26 | 0.68 | 1.18 | 0.88 | 1.2 | 0.96 | 1.62 | 1.33 | 1.85 |

TABLE 20
Shear Strength (CTH)

| | Shear Holding |
|---|---|
| | Time (minutes) |
| | 8.8 lbs/in² |
| Example | FEN |
| E23 | >25000 |
| E24 | 21400 |
| E25 | 9520 |
| E26 | 18817 |

### Examples E27-E30

The pressure sensitive adhesive formulations for Examples E27-E30 were prepared following the general procedure described for Examples E1-E12, except instead of using AEROSIL R 812S, the silica used was Surface Modified Silica nanoparticles prepared as described above. Adhesive transfer tapes and multi-layer composite tapes were prepared as described above. The pressure sensitive adhesive formulations and percent solids used for coating are provided in Table 21. Rheological properties of the pressure sensitive adhesives are provided in Table 22.

TABLE 21
Adhesive Formulations

| | MQ Resin | Silica | SPU | % |
|---|---|---|---|---|
| Example | (wt %) | (wt %) | (wt %) | Solids |
| E27 | 40 | 4 | 56 | 28 |
| E28 | 40 | 12 | 48 | 28 |
| E29 | 50 | 4 | 46 | 28 |
| E30 | 50 | 12 | 38 | 28 |

TABLE 22
Rheological Properties at 25° C.

| | Storage | Loss | |
|---|---|---|---|
| Example | Modulus (Pa) | Modulus (Pa) | Tan δ |
| E27 | 147737 | 19254 | 0.130327 |
| E28 | 305967 | 66041 | 0.215842 |
| E29 | 186283 | 70025 | 0.375909 |
| E30 | 685856 | 354706 | 0.517172 |

TABLE 23
90° Angle Peel adhesion (with DUAL LOCK backing)

| | Average of Actual | | | Average | | |
|---|---|---|---|---|---|---|
| | Max Load (oz/in) | | | Damage Code | | |
| | CS | | | CS | | |
| Example | 1 hour | 1 week | 1month | 1 hour | 1 week | 1 month |

12 in/min

| | | | | | | |
|---|---|---|---|---|---|---|
| E27 | 43.3 | NT | NT | 5 | NT | NT |
| E28 | 47.93 | NT | NT | 5 | NT | NT |
| E29 | 56.24 | NT | NT | 5 | NT | NT |
| E30 | 37.93 | NT | NT | 5 | NT | NT |

90 in/min

| | | | | | | |
|---|---|---|---|---|---|---|
| E27 | 52.55 | NT | NT | 5 | NT | NT |
| E28 | 49.16 | NT | NT | 5 | NT | NT |
| E29 | 56.25 | NT | NT | 5 | NT | NT |
| E30 | 57.92 | NT | NT | 5 | NT | NT |

TABLE 24
Shear Strength

| | Shear Holding |
|---|---|
| | Time (minutes) |
| | 8.8 lbs/in² |
| Example | FEN |
| E27 | >61000 |
| E28 | >61000 |
| E29 | >61000 |
| E30 | >61000 |

### Examples E31-E46

The pressure sensitive adhesive formulations for Examples E31-E-46 were prepared following the general procedure described for Examples E1-E12. Adhesive transfer tapes and multi-layer composite tapes were prepared as described above. The pressure sensitive adhesive formulations and percent solids used for coating are provided in Table 25. Rheological properties of the pressure sensitive adhesives are provided in Table 26.

TABLE 25
Adhesive Formulations

| | MQ Resin | Fumed Silica | SPU | % |
|---|---|---|---|---|
| Example | (wt %) | (wt %) | (wt %) | Solids |
| E31 | 37 | 7 | 56 | 30 |
| E32 | 37 | 9 | 54 | 30 |
| E33 | 37 | 11 | 52 | 30 |
| E34 | 37 | 13 | 50 | 30 |
| E35 | 39 | 7 | 54 | 30 |
| E36 | 39 | 9 | 52 | 30 |
| E37 | 39 | 11 | 50 | 30 |
| E38 | 39 | 13 | 48 | 30 |
| E39 | 41 | 7 | 52 | 30 |
| E40 | 41 | 9 | 50 | 30 |
| E41 | 41 | 11 | 48 | 30 |
| E42 | 41 | 13 | 46 | 30 |
| E43 | 43 | 7 | 50 | 30 |
| E44 | 43 | 9 | 48 | 30 |
| E45 | 43 | 11 | 46 | 30 |
| E46 | 43 | 13 | 44 | 30 |

TABLE 26
Rheological Properties at 25° C.

| | Storage | Loss | |
|---|---|---|---|
| Example | Modulus (Pa) | Modulus (Pa) | Tan δ |
| E31 | 197014 | 22874 | 0.12 |
| E32 | 330112 | 42862 | 0.13 |
| E33 | 473480 | 70505 | 0.15 |
| E34 | 450401 | 66592 | 0.15 |
| E35 | 221675 | 25031 | 0.11 |
| E36 | 291325 | 40336 | 0.14 |
| E37 | 371763 | 59676 | 0.16 |
| E38 | 488377 | 89349 | 0.18 |
| E39 | 262777 | 35091 | 0.13 |
| E40 | 327394 | 50490 | 0.15 |
| E41 | 412718 | 69240 | 0.17 |
| E42 | 546231 | 121311 | 0.22 |
| E43 | 281444 | 46808 | 0.17 |
| E44 | 359677 | 62991 | 0.18 |
| E45 | 474035 | 94089 | 0.20 |
| E46 | 635397 | 147804 | 0.23 |

TABLE 27
90° Angle Peel adhesion (with DUAL LOCK backing)

| | Average of Actual | Average |
|---|---|---|
| | Max Load (oz/in) | Damage Code |
| | SWBB | |
| Example | 1 hour dwell time | |
| | 12 in/min | |
| E31 | 35.10 | 5 |
| E32 | 28.79 | 4 |
| E33 | 16.13 | 0 |
| E34 | 21.87 | 2 |
| E35 | 30.88 | 5 |
| E36 | 30.97 | 4 |
| E37 | 27.65 | 2 |
| E38 | 19.17 | 0 |
| E39 | 37.39 | 5 |
| E40 | 29.93 | 4.5 |
| E41 | 30.60 | 3.5 |
| E42 | 16.84 | 0.5 |
| E43 | 37.29 | 5 |
| E44 | 27.39 | 2.5 |
| E45 | 16.28 | 0 |
| E46 | 12.59 | 0 |
| | 90 in/min | |
| E31 | 39.23 | 2.5 |
| E32 | 34.42 | 3 |
| E33 | 30.50 | 3.5 |
| E34 | 17.49 | 0 |
| E35 | 42.14 | 4.5 |
| E36 | 39.13 | 3 |
| E37 | 24.63 | 2.5 |
| E38 | 19.10 | 1 |
| E39 | 37.10 | 4 |
| E40 | 23.54 | 0 |
| E41 | 28.68 | 2 |
| E42 | 36.92 | 4.5 |
| E43 | 38.89 | 4.5 |
| E44 | 27.22 | 0.5 |
| E45 | 27.83 | 2 |
| E46 | 37.05 | 2.5 |

TABLE 28
Shear Strength

| | Shear Holding |
|---|---|
| | Time (minutes) |
| | 8.8 lbs/in² |
| Example | FEN |
| E31 | >97000 |
| E32 | 10700 |
| E33 | >104900 |
| E34 | >104900 |
| E35 | >104900 |
| E36 | >104900 |
| E37 | >104900 |
| E38 | >104900 |
| E39 | >104900 |
| E40 | >104900 |
| E41 | >104900 |
| E42 | >104900 |
| E43 | >104900 |
| E44 | >104900 |
| E45 | >104900 |
| E46 | >104900 |

### Examples E47-E55 and Comparative Examples CE6-CE8

### Silicone Polydisiloxane Polyoxamide Block Copolymer Pressure Sensitive Adhesive Formulations

Fumed silica (AEROSIL R 812 S, available from Evonik Corporation, Parsippany, N.J.) was added to a tared, 32 ounce jar and was diluted with toluene and MQ tackifier resin (SR545, available from Momentive Performance Materials, Watertown, N.Y.). The resulting mixture was subjected to a paint shaker, set to high, for 15 minutes which produced a thick, iridescent dispersion. An elastomeric solution of a polydisiloxane polyoxamide block copolymer (in 77/23 ethyl acetate/isopropyl alcohol) was then added to the jar, sealed, and mixed by placing the jar on a roller for 18 hours set to approximately 25 rpm. The polydisiloxane polyoxamide block copolymer (PDMS I) used was the same as that used for the pressure sensitive adhesive composition of Example 12 in U.S. Pat. No. 8,765,881. Example 12 refers to an amine equivalent weight of 10,174 g/mol, or amolecular weight of about 20,000 g/mol. Adhesive transfer tapes and multi-layer composite tapes were prepared as described above. The pressure sensitive adhesive formulations and percent solids used for coating are provided in Table 29.

TABLE 29
Adhesive Formulations

| | MQ Resin | Fumed Silica | PDMS I | |
|---|---|---|---|---|
| Example | (wt %) | (wt %) | (wt %) | % Solids |
| CE6 | 30 | 0 | 70 | 28.03 |
| CE7 | 45 | 0 | 55 | 28.00 |
| CE8 | 60 | 0 | 40 | 28.06 |
| E47 | 45 | 10 | 45 | 28.00 |
| E48 | 45 | 10 | 45 | 28.07 |
| E49 | 45 | 10 | 45 | 28.02 |
| E50 | 45 | 10 | 45 | 28.37 |
| E51 | 60 | 10 | 30 | 28.05 |
| E52 | 30 | 10 | 60 | 28.23 |
| E53 | 30 | 20 | 50 | 27.26 |
| E54 | 60 | 20 | 20 | 28.20 |
| E55 | 45 | 20 | 35 | 28.12 |

TABLE 30
90° Angle Peel Adhesion

| | Average of | Average of | Average |
|---|---|---|---|
| | Actual Avg | Actual Max | Damage |
| | Load (oz/in) | Load (oz/in) | Code |
| | 1 hour dwell time | | |
| Example | 90 in/min | | |
| CE6 | 29.93 | 34.20 | 0 |
| CE7 | 81.31 | 88.59 | 2 |
| CE8 | 8.11 | 63.09 | 1.5 |
| E47 | 9.36 | 16.65 | 0 |
| E48 | 6.36 | 18.08 | 0 |
| E49 | 7.24 | 21.51 | 0 |
| E50 | 10.07 | 14.86 | 0 |
| E51 | NT* | NT* | NT* |
| E52 | 14.47 | 21.59 | 0 |
| E53 | 7.51 | 15.52 | 0 |
| E54 | NT* | NT* | NT* |
| E55 | 0.44 | 6.73 | 0 |

*E51 and E54 solutions could not be adequately coated, so no PSAs were tested for 90° Angle Peel Adhesion, Shear Strength, or Package Weight Claim.

TABLE 31
Shear Strength (CTH)

| | Shear Holding Time | |
|---|---|---|
| | (minutes) 8.8 lbs/in² | |
| Example | FEN | Glass |
| CE6 | 12 | >58900 |
| CE7 | >60000 | >58900 |
| CE8 | 6027 | >58900 |
| E47 | >60000 | >58900 |
| E48 | 610 | >58900 |
| E49 | >60000 | >58900 |
| E50 | >60000 | >58900 |
| E51 | NT | NT |
| E52 | .60000 | >58900 |
| E53 | 21516 | >58900 |
| E54 | NT | NT |
| E55 | 2 | >58900 |

TABLE 32
Package Weight Claim (shower chamber)

| | Shear Holding |
|---|---|
| Example | Time (Days) |
| CE6 | 3 |
| CE7 | 21 |
| CE8 | 21 |
| E47 | 21 |
| E48 | 21 |
| E49 | 21 |
| E50 | 21 |
| E51 | NT |
| E52 | 12 |
| E53 | 12 |
| E54 | NT |
| E55 | 21 |

### Examples E56-E61 and Comparative Examples CE9-CE11

### Addition Cure Silicone Pressure Sensitive Adhesive Formulations

In a first step, silica powder was individually added to toluene to make a silica stock solution. After addition of the silica to toluene, the mixture was placed on a shaker with moderate intensity and was shaken for 10 minutes. Subsequently the sample was placed on a roller for mixing and was left there until it was time to use it for the next step. In the next step, the appropriate amount of 0.2 weight fraction PDMS (PDMS II) solution (Wacker 948, supplied as a 30 wt % solids solution in toluene, available from Wacker Chemie AG, Germany) was weighed based on the formulation and was added to an 8 oz jar. MQ tackifier resin (SR545, supplied as a 30 wt % solids solution in toluene, available from Momentive Performance Materials, Watertown, N.Y.) was then added to the PDMS solution in the appropriate amount. Then silica stock solution was added to the PDMS/MQ resin mixture. Finally, crosslinker (SYL-OFF 7678 Crosslinker, available from Dow Chemical Company, Midland, Mich.) was added to the solution in the appropriate amount (based on hydride to vinyl ratio of 6) and the solution was placed on a roller for mixing and left on the roller overnight to achieve for proper mixing. Just before coating the adhesive, 40 ppm platinum catalyst (Platinum-divinyltetramethyldisiloxane Complex, available from Gelest, Morrisville, Pa.) was added to the solution. The solution was placed on the roller for mixing for 10 minutes before the coating. Adhesive transfer tapes and multi-layer composite tapes were prepared as described above. The pressure sensitive adhesive formulations are provided in Table 33.

TABLE 33
Adhesive Formulations

| | A | B | C |
|---|---|---|---|
| | PDMS II | MQ Resin | Silica |
| Example | wtf (%) | wtf (%) | Phr/100 |
| CE9 | 0.55 | 0.45 | 0 |
| CE10 | 0.50 | 0.50 | 0 |
| CE11 | 0.45 | 0.55 | 0 |
| 56 | 0.55 | 0.45 | 0.05 |
| 57 | 0.50 | 0.50 | 0.05 |
| 58 | 0.45 | 0.55 | 0.05 |
| 59 | 0.55 | 0.45 | 0.10 |
| 60 | 0.50 | 0.50 | 0.10 |
| 61 | 0.45 | 0.55 | 0.10 |

A + B = 100 parts;
C extra part based on 100 parts of A + B

TABLE 34
90° Angle Peel Adhesion

| | Average of Actual | | | Average of Actual | | |
|---|---|---|---|---|---|---|
| | Avg Load (oz/in) | | | Max Load (oz/in) | | |
| Example | 1 hour | 1 week | 1 month | 1 hour | 1 week | 1 month |

SWBB

| | | | | | | |
|---|---|---|---|---|---|---|
| CE9 | 25.6 | 29.21 | 35.26 | 33.89 | 47.86 | 52.52 |
| CE10 | 21.97 | 22.37 | 22.54 | 43.82 | 46.00 | 64.39 |
| CE11 | 22.59 | 19.51 | 22.97 | 41.68 | 49.60 | 55.97 |
| 56 | 30.14 | 28.91 | 38.94 | 36.84 | 33.59 | 43.44 |
| 57 | 25.43 | 22.74 | 24.57 | 37.81 | 34.87 | 55.77 |
| 58 | 22.44 | 22.21 | 26.08 | 50.86 | 38.50 | 43.92 |
| 59 | 18.48 | 20.82 | 22.83 | 23.17 | 26.67 | 27.21 |
| 60 | 25.45 | 25.565 | 32.24 | 31.74 | 37.86 | 36.52 |
| 61 | 25.70 | 33.90 | 36.22 | 33.05 | 43.37 | 42.59 |

Glass

| | | | | | | |
|---|---|---|---|---|---|---|
| CE9 | 22.90 | 26.06 | 27.48 | 30.55 | 30.88 | 30.42 |
| CE10 | 28.12 | 32.36 | 38.89 | 33.10 | 43.97 | 57.23 |
| CE11 | 37.12 | 40.33 | 53.55 | 44.205 | 48.67 | 66.34 |
| 56 | 19.58 | 23.27 | 24.00 | 25.02 | 32.16 | 28.65 |
| 57 | 24.91 | 33.31 | 41.72 | 29.35 | 40.76 | 53.14 |
| 58 | 35.63 | 38.32 | 46.93 | 43.98 | 44.53 | 53.74 |
| 59 | 17.48 | 19.90 | 24.43 | 19.12 | 25.98 | 34.38 |
| 60 | 23.99 | 28.55 | 44.73 | 29.74 | 38.00 | 52.57 |
| 61 | 37.39 | 48.62 | 39.82 | 43.84 | 62.44 | 46.95 |

TABLE 35
Average of Damage Code
Average of Damage Code
SWBB

| Example | 1 hour | 1 week | 1 month |
|---|---|---|---|
| CE9 | 4.5 | 5 | 5 |
| CE10 | 5 | 5 | 5 |
| CE11 | 5 | 5 | 5 |
| 56 | 2.5 | 0 | 2 |
| 57 | 4.5 | 5 | 5 |
| 58 | 5 | 5 | 5 |
| 59 | 0 | 0 | 0 |
| 60 | 0 | 4.5 | −0.5 |
| 61 | 3.5 | 2 | 2 |

Glass

| | | | |
|---|---|---|---|
| CE9 | 0 | 0 | 0 |
| CE10 | 0 | 0 | 0 |
| CE11 | 0 | 0 | 0 |
| 56 | 0 | 0 | 0 |
| 57 | 0 | 0 | 0 |
| 58 | 0 | 0 | 0 |
| 59 | 0 | 0 | 0 |
| 60 | 0 | 0 | −1 |
| 61 | −0.5 | −1 | −1 |

* Negative Damage Codes are a sign of 2-bond failures which is the failure between the adhesive and backing.

### EMBODIMENTS

1. An adhesive composition comprising:
(a) a polydiorganosiloxane polyoxamide copolymer, a silicate tackifying resin in an amount of between about 10 wt % and about 70 wt %, and fumed silica in between about 0.1 wt % and about 20 wt %;
(b) a silicone polyurea block copolymer, a silicate tackifying resin in an amount of between about 10 wt % and about 70 wt %, and fumed silica in an amount between about 0.1 wt % and about 20 wt %; or
(c) an addition cure silicone, a silicate tackifying resin in an amount of between about 10 wt % and about 70 wt %, and fumed silica in an amount between about 0.1 wt % and about 20 wt %.

2. The adhesive composition of embodiment 1, wherein the adhesive composition comprises a polydiorganosiloxane polyoxamide copolymer, a silicate tackifying resin in an amount of between about 10 wt % and about 70 wt %, and fumed silica in between about 0.1 wt % and about 20 wt %.

3. The adhesive composition of embodiment 1, wherein the adhesive composition comprises a silicone polyurea block copolymer, a silicate tackifying resin in an amount of between about 10 wt % and about 70 wt %, and fumed silica in an amount between about 0.1 wt % and about 20 wt %;

4. The adhesive composition of embodiment 1, wherein the adhesive composition comprises an addition cure silicone, a silicate tackifying resin in an amount of between about 10 wt % and about 70 wt %, and fumed silica in an amount between about 0.1 wt % and about 20 wt %.

5. The adhesive composition of embodiments 1-4, wherein the adhesive composition is a pressure sensitive adhesive.

6. The adhesive composition of embodiments 1-4, wherein the adhesive composition is a heat activated adhesive.

7. The adhesive composition of embodiments 1-6, wherein the silicate tackifying resin is an MQ silicate tackifying resin.

8. The adhesive composition of any of the previous embodiments, wherein the tackifier is present in an amount of between about 20 weight percent and about 60 weight percent based on the weight of the adhesive composition.

9. The adhesive composition of embodiment 8, wherein the tackifier is present in an amount of between about 40 weight percent and about 60 weight percent based on the weight of the adhesive composition.

10. The adhesive composition of any of the previous embodiments, wherein the fumed silica is present in an amount of between about 1 weight percent and about 15 weight percent based on the weight of the adhesive composition.

11. The adhesive composition of embodiment 10, wherein the fumed silica is present in an amount of between about 2 weight percent and about 10 weight percent based on the weight of the adhesive composition.

12. An article comprising: a substrate; and an adhesive layer adjacent to at least one surface of the substrate, the adhesive layer comprising at least one of
(a) a polydiorganosiloxane polyoxamide copolymer, a silicate tackifying resin in an amount of between about 10 wt % and about 70 wt %, and fumed silica in between about 0.1 wt % and about 20 wt %;
(b) a silicone polyurea block copolymer, a silicate tackifying resin in an amount of between about 10 wt % and about 70 wt %, and fumed silica in an amount between about 0.1 wt % and about 20 wt %; or
(c) an addition cure silicone, a silicate tackifying resin in an amount of between about 10 wt % and about 70 wt %, and fumed silica in an amount between about 0.1 wt % and about 20 wt %.

13. The article of embodiment 12, wherein the adhesive layer comprises a polydiorganosiloxane polyoxamide copolymer, a silicate tackifying resin in an amount of between about 10 wt % and about 70 wt %, and fumed silica in between about 0.1 wt % and about 20 wt %.

14. The article of embodiment 12, wherein the adhesive layer comprises a silicone polyurea block copolymer, a silicate tackifying resin in an amount of between about 10 wt % and about 70 wt %, and fumed silica in an amount between about 0.1 wt % and about 20 wt %;

15. The article of embodiment 12, wherein the adhesive composition comprises an addition cure silicone, a silicate tackifying resin in an amount of between about 10 wt % and about 70 wt %, and fumed silica in an amount between about 0.1 wt % and about 20 wt %.

16. The article of embodiments 12-15, wherein the adhesive layer is a heat activated adhesive.

17. The article of embodiments 12-15, wherein the adhesive layer is a pressure sensitive adhesive.

18. The article of embodiments 12-15, wherein the silicate tackifying resin comprises a MQ silicate tackifying resin.

19. The article of any of the previous embodiments, wherein the tackifier is present in an amount of between about 30 weight percent and about 60 weight percent based on the weight of the adhesive composition.

20. The article of embodiment 18, wherein the tackifier is present in an amount of between about 40 weight percent and about 60 weight percent based on the weight of the adhesive composition.

21. The article of any of the previous embodiments, wherein the fumed silica is present in an amount of between about 2 weight percent and about 10 weight percent based on the weight of the adhesive composition.

22. The article of embodiment 21, wherein the fumed silica is present in an amount of between about 3 weight percent and about 9 weight percent based on the weight of the adhesive composition.

23. The article of embodiments 11-22, having a peel adhesion between about 0.5 oz/in and about 120 oz/in and Shear Holding of at least about 1500 minutes.

24. The article of embodiments 11-23, having Static Shear of at least about 30,000 minutes.

25. The article of embodiment 24, having a Static Shear of at least about 50,000 minutes.

26. The article of embodiments 11-23, and further comprising a release liner in contact with a surface of the adhesive layer.

27. The article of embodiment 24, wherein the peel adhesion of the adhesive layer to the release liner is no greater than 100 oz/in.

28. The article of embodiment 24, wherein the peel adhesion of the adhesive layer to the release liner is no greater than 50 oz/in.

29. The article of embodiments 24-28, wherein the fumed silica has an average particle size of at least about 200 nanometers and no greater than about 20 microns.

30. The article of embodiment 29, wherein the fumed silica has an average particle size of at least about 1 micron and no greater than about 15 microns.

31. A method of preparing an adhesive article, the method comprising:
providing an adhesive composition of any of embodiments 1-11; and applying the adhesive composition to a surface of a substrate.

The recitation of all numerical ranges by endpoint is meant to include all numbers subsumed within the range (i.e., the range 1 to 10 includes, for example, 1, 1.5, 3.33, and 10).

The terms first, second, third and the like in the description and in the embodiments, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the embodiments are used for descriptive purposes and not necessarily for describing relative positions. It is to be understood that the terms so used are interchangeable under appropriate circumstances and that the embodiments of the invention described herein are capable of operation in other orientations than described or illustrated herein.

All references mentioned herein are hereby incorporated by reference in their entirety.

It is understood that connector systems may have many different properties that make them particularly suitable for certain applications or for connecting certain types of objects together. Thus, in accordance with the present invention, any such connector system can be used, but the chosen connector system can be advantageously picked based upon its properties that make it particularly suitable for a specific application or for connecting certain types of objects together.

1. A pressure sensitive or heat activated adhesive composition comprising:
(a) a polydiorganosiloxane polyoxamide copolymer, a silicate tackifying resin in an amount of between about 10 wt % and about 70 wt %, and fumed silica in between about 0.1 wt % and about 20 wt %;
(b) a silicone polyurea block copolymer, a silicate tackifying resin in an amount of between about 10 wt % and about 70 wt %, and fumed silica in an amount between about 0.1 wt % and about 20 wt %; or
(c) an addition cure silicone, a silicate tackifying resin in an amount of between about 10 wt % and about 70 wt %, and fumed silica in an amount between about 0.1 wt % and about 20 wt %.

2. The adhesive composition of claim 1, wherein the adhesive composition comprises a polydiorganosiloxane polyoxamide copolymer, a silicate tackifying resin in an amount of between about 10 wt % and about 70 wt %, and fumed silica in between about 0.1 wt % and about 20 wt %.

3. The adhesive composition of claim 1, wherein the adhesive composition comprises a silicone polyurea block copolymer, a silicate tackifying resin in an amount of between about 10 wt % and about 70 wt %, and fumed silica in an amount between about 0.1 wt % and about 20 wt %;

4. The adhesive composition of claim 1, wherein the silicate tackifying resin is an MQ silicate tackifying resin.

5. The adhesive composition of claim 1, wherein the tackifier is present in an amount of between about 20 weight percent and about 60 weight percent based on the weight of the adhesive composition.

6. The adhesive composition of claim 5, wherein the tackifier is present in an amount of between about 40 weight percent and about 60 weight percent based on the weight of the adhesive composition.

7. The adhesive composition of claim 1, wherein the fumed silica is present in an amount of between about 2 weight percent and about 12 weight percent based on the weight of the adhesive composition.

8. The adhesive composition of claim 1, wherein the fumed silica is present in an amount of between about 3 weight percent and about 9 weight percent based on the weight of the adhesive composition.

9. An article comprising:
a substrate; and
an adhesive layer adjacent to at least one surface of the substrate, the adhesive layer comprising at least one of
(a) a polydiorganosiloxane polyoxamide copolymer, a silicate tackifying resin in an amount of between about 10 wt % and about 70 wt %, and fumed silica in between about 0.1 wt % and about 20 wt %;
(b) a silicone polyurea block copolymer, a silicate tackifying resin in an amount of between about 10 wt % and about 70 wt %, and fumed silica in an amount between about 0.1 wt % and about 20 wt %; or
(c) an addition cure silicone, a silicate tackifying resin in an amount of between about 10 wt % and about 70 wt %, and fumed silica in an amount between about 0.1 wt % and about 20 wt %.

10. The article of claim 9, wherein the adhesive layer comprises a polydiorganosiloxane polyoxamide copolymer, a silicate tackifying resin in an amount of between about 10 wt % and about 70 wt %, and fumed silica in between about 0.1 wt % and about 20 wt %.

11. The article of claim 9, wherein the adhesive layer comprises a silicone polyurea block copolymer, a silicate tackifying resin in an amount of between about 10 wt % and about 70 wt %, and fumed silica in an amount between about 0.1 wt % and about 20 wt %;

12. The article of claim 9, wherein the silicate tackifying resin comprises a MQ silicate tackifying resin.

13. The article of claim 9, wherein the tackifier is present in an amount of between about 40 weight percent and about 60 weight percent based on the weight of the adhesive composition.

14. The article of claim 9, wherein the fumed silica is present in an amount of between about 2 weight percent and about 15 weight percent based on the weight of the adhesive composition.

15. The article of claim 14, wherein the fumed silica is present in an amount of between about 3 weight percent and about 9 weight percent based on the weight of the adhesive composition.

16. The article of claim 9, having a peel adhesion between about 0.5 oz/in and about 120 oz/in and Shear Holding of at least about 1500 minutes.

17. The article of claim 9, having Static Shear of at least about 30,000 minutes.

18. The article of claim 9, and further comprising a release liner in contact with a surface of the adhesive layer, and wherein the peel adhesion of the adhesive layer to the release liner is no greater than 100 oz/in.

19. The article of claim 18, wherein the peel adhesion of the adhesive layer to the release liner is no greater than 50 oz/in.

20. The article of claim 9, wherein the fumed silica has an average particle size of at least about 1 micron and no greater than about 15 microns.
